(19) United States
(12) Patent Application Publication
(10) Pub. No.: US 2022/0256223 A1
(43) Pub. Date: Aug. 11, 2022

(54) INFORMATION PROCESSING APPARATUS, OPERATION TERMINAL, AND INFORMATION PROCESSING METHOD

(71) Applicant: SONY GROUP CORPORATION, TOKYO (JP)

(72) Inventors: NATSUKI ISHIMOTO, TOKYO (JP); TARO SUNADA, TOKYO (JP); SATOSHI YAMADA, TOKYO (JP); YUSUKE AOSHIMA, TOKYO (JP); KOZO MORITA, TOKYO (JP); NAOKI SAITO, TOKYO (JP)

(21) Appl. No.: 17/595,628

(22) PCT Filed: May 21, 2020
(86) PCT No.: PCT/JP2020/020185

§ 371 Date: Nov. 19, 2021

(30) Foreign Application Priority Data
May 30, 2019 (JP) 2019-100957
Dec. 26, 2019 (JP) 2019-235744

(51) Int. Cl. H04N 21/422

(52) U.S. Cl. CPC H04N 21/42202; H04N 21/42222; H04N 21/42203

(57) ABSTRACT

An information processing apparatus according to the present disclosure includes: a generator configured to generate control information to be used to perform light emission control of a light-emitting unit provided in an operation terminal; and a transmitter configured to transmit the control information to the operation terminal.

### TECHNICAL FIELD

The present disclosure relates to an information processing apparatus to be operated by an operation terminal, the operation terminal, and an information processing method to be used in such an information processing apparatus.

### BACKGROUND ART

Information processing apparatuses are often configured to be operable by an operation terminal, such as a remote control apparatus. For example, PTL 1 discloses a television receiver operable by a remote control apparatus.

### CITATION LIST

### Patent Literature

PTL 1: Japanese Unexamined Patent Application Publication No. 2014-110517

### SUMMARY OF THE INVENTION

Incidentally, information processing apparatuses are desired to achieve high user's convenience, and are expected to be further improved in convenience.

It is desirable to provide an information processing apparatus, an operation terminal, and an information processing method that make it possible to enhance user's convenience.

An information processing apparatus according to one embodiment of the present disclosure includes a generator and a transmitter. The generator is configured to generate control information to be used to perform light emission control of a light-emitting unit provided in an operation terminal. The transmitter is configured to transmit the control information to the operation terminal.

An operation terminal according to one embodiment of the present disclosure includes an operation unit, a light-emitting unit, a receiver, and a controller. The operation unit is configured to accept an operation of a user. The light-emitting unit is configured to emit light from an operation surface of the operation unit. The receiver is configured to receive control information transmitted from an information processing apparatus. The controller is configured to perform light emission control of the light-emitting unit on the basis of the control information.

An information processing method according to one embodiment of the present disclosure includes: generating, by an information processing apparatus, control information to be used to perform light emission control of a light-emitting unit provided in an operation terminal; transmitting, by the information processing apparatus, the control information to the operation terminal; and performing, by the operation terminal, the light emission control of the light-emitting unit on the basis of the control information transmitted from the information processing apparatus.

In the information processing apparatus and the information processing method according to one embodiment of the present disclosure, control information to be used to perform the light emission control of the light-emitting unit provided in the operation terminal is generated, and the control information is transmitted to the operation terminal.

In the operation terminal and the information processing method according to one embodiment of the present disclosure, control information transmitted from the information processing apparatus is received, and the light emission control of the light-emitting unit provided in the operation terminal is performed on the basis of the control information.

### BRIEF DESCRIPTION OF DRAWINGS

FIG. 1 is a block diagram illustrating a configuration example of a display system according to a first embodiment of the present disclosure.

FIG. 2 is an explanatory diagram illustrating a configuration example of an operation terminal according to one embodiment.

FIG. 3 is a flowchart illustrating an action example of the operation terminal illustrated in FIG. 1.

FIG. 4 is an explanatory diagram illustrating an action example of a control unit 37 illustrated in FIG. 1.

FIG. 5 is a sequence diagram illustrating an action example of the display system illustrated in FIG. 1.

FIG. 6A is a timing chart illustrating an action example of a light emission controller 37 and a light-emitting unit 32 illustrated in FIG. 1.

FIG. 6B is another timing chart illustrating an action example of the light emission controller 37 and the light-emitting unit 32 illustrated in FIG. 1.

FIG. 6C is another timing chart illustrating an action example of the light emission controller 37 and the light-emitting unit 32 illustrated in FIG. 1.

FIG. 6D is another timing chart illustrating an action example of the light emission controller 37 and the light-emitting unit 32 illustrated in FIG. 1.

FIG. 6E is another timing chart illustrating an action example of the light emission controller 37 and the light-emitting unit 32 illustrated in FIG. 1.

FIG. 6F is another timing chart illustrating an action example of the light emission controller 37 and the light-emitting unit 32 illustrated in FIG. 1.

FIG. 6G is another timing chart illustrating an action example of the light emission controller 37 and the light-emitting unit 32 illustrated in FIG. 1.

FIG. 6H is another timing chart illustrating an action example of the light emission controller 37 and the light-emitting unit 32 illustrated in FIG. 1.

FIG. 7 is a flowchart illustrating an action example of an operation terminal according to a modification example of the first embodiment.

FIG. 8 is a flowchart illustrating an action example of a display apparatus according to the modification example of the first embodiment.

FIG. 9 is a sequence diagram illustrating an action example of a display system according to the modification example of the first embodiment.

FIG. 10 is a block diagram illustrating a configuration example of a display system according to another modification example of the first embodiment.

FIG. 11 is a block diagram illustrating a configuration example of a display system according to another modification example of the first embodiment.

FIG. 12 is an explanatory diagram illustrating a configuration example of an operation terminal according to another modification example of the first embodiment.

FIG. 13 is a block diagram illustrating a configuration example of a display system according to a second embodiment.

FIG. 14 is a flowchart illustrating an action example of a display apparatus illustrated in FIG. 13.

FIG. 15 is a sequence diagram illustrating an action example of the display system illustrated in FIG. 13.

FIG. 16 is a block diagram illustrating a configuration example of a display system according to a third embodiment.

FIG. 17 is a flowchart illustrating an action example of a display apparatus illustrated in FIG. 16.

FIG. 18 is a sequence diagram illustrating an action example of the display system illustrated in FIG. 16.

FIG. 19 is a block diagram illustrating a configuration example of a display system according to a fourth embodiment.

FIG. 20A is a flowchart illustrating an action example of a display apparatus illustrated in FIG. 19.

FIG. 20B is a flowchart illustrating the action example of the display apparatus illustrated in FIG. 19.

FIG. 21 is a sequence diagram illustrating an action example of the display system illustrated in FIG. 19.

FIG. 22 is a block diagram illustrating a configuration example of a display system according to a fifth embodiment.

FIG. 23 is a flowchart illustrating an action example of a display apparatus illustrated in FIG. 22.

FIG. 24 is a sequence diagram illustrating an action example of the display system illustrated in FIG. 22.

FIG. 25 is a block diagram illustrating a configuration example of a display system according to a modification example of the fifth embodiment.

FIG. 26 is a flowchart illustrating an action example of a display apparatus illustrated in FIG. 25.

FIG. 27 is a block diagram illustrating a configuration example of a display system according to another modification example of the fifth embodiment.

FIG. 28 is a block diagram illustrating a configuration example of a display system according to a sixth embodiment.

FIG. 29 is a flowchart illustrating an action example of a display apparatus illustrated in FIG. 28.

FIG. 30 is a sequence diagram illustrating an action example of the display system illustrated in FIG. 28.

### MODES FOR CARRYING OUT THE INVENTION

In the following, some embodiments of the present disclosure are described in detail with reference to the drawings. It is to be noted that description is given in the following order.

1. First Embodiment (an example of controlling a light emission action on the basis of brightness of an environment)
2. Second Embodiment (an example of controlling a light emission action on the basis of content being displayed)
3. Third Embodiment (an example of controlling a light emission action on the basis of a color of an image being displayed)
4. Fourth Embodiment (an example of controlling a light emission action on the basis of notification information to a user)
5. Fifth Embodiment (an example of controlling a light emission action on the basis of a selected voice assistant)
6. Sixth Embodiment (an example of controlling a light emission action on the basis of external equipment to be used)

### 1. First Embodiment

### Configuration Example

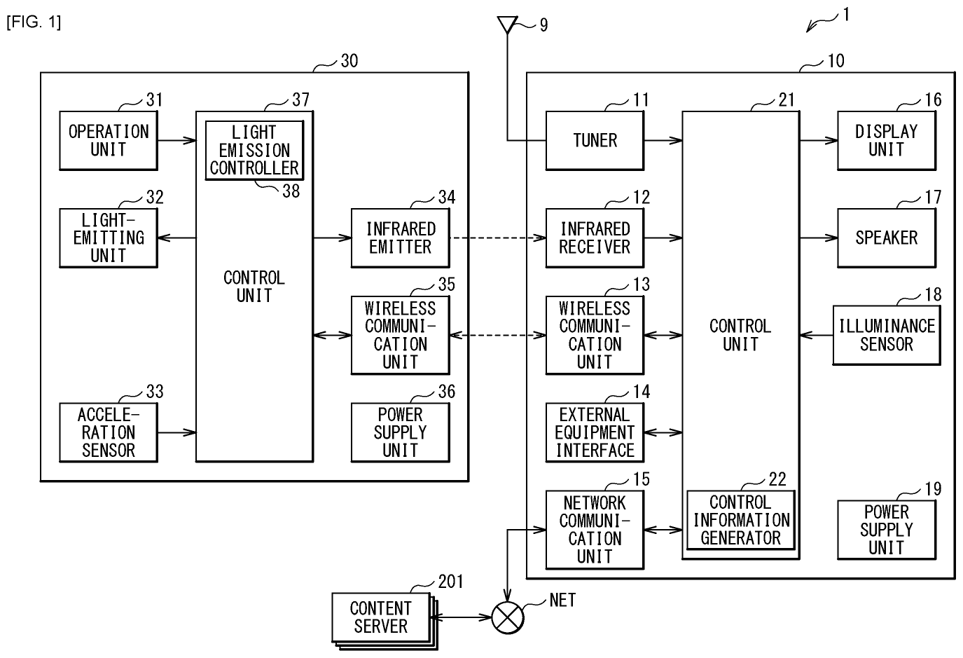

FIG. 1 illustrates a configuration example of a display system 1 including an information processing apparatus (a display apparatus 10) according to a first embodiment. Note that an information processing method according to one embodiment of the present disclosure will be described together, because it is implemented by the present embodiment. The display system 1 includes the display apparatus 10 and an operation terminal 30.

### (Display Apparatus 10)

The display apparatus 10 is a so-called television receiver, and includes a tuner 11, an infrared receiver 12, a wireless communication unit 13, an external equipment interface 14, a network communication unit 15, a display unit 16, a speaker 17, an illuminance sensor 18, a power supply unit 19, and a control unit 21.

The tuner 11 is configured to select a desired video signal (stream) from digital broadcast waves received by an antenna 9.

The infrared receiver 12 is configured to receive an infrared signal transmitted from the operation terminal 30 and giving an instruction for an action of the display apparatus 10.

The wireless communication unit 13 is configured to exchange information with the operation terminal 30 by using short-range wireless communication. In this example, the wireless communication unit 13 communicates with the operation terminal 30 by using Bluetooth (registered trademark). Note that, without being limited thereto, Zigbee (registered trademark), a wireless LAN (Local Area Network), or the like may be used, for example. The wireless communication unit 13 transmits, to the operation terminal 30, control information INF to be used to control a light emission action of a light-emitting unit 32 in the operation terminal 30, as will be described later.

The external equipment interface 14 is configured to communicate with external equipment, such as a hard disk recorder, for example. The external equipment interface 14 communicates with the external equipment by using, for example, HDMI (registered trademark).

The network communication unit 15 is coupled to the Internet NET, and is configured to perform network communication with a communication partner via the Internet NET. For example, the network communication unit 15 is able to receive video information by streaming, from a content server 201 of moving-image streaming service.

The display unit 16 is configured to display video on the basis of, for example, the video signal selected by the tuner 11. The display unit 16 is configured by using, for example, a liquid crystal display, an organic EL (Electro Luminescence) display, or the like.

The speaker 17 is configured to emit sound on the basis of, for example, the video signal selected by the tuner 11.

The illuminance sensor 18 is configured to detect brightness of an environment around the display apparatus 10. The control unit 21 adjusts a display luminance in the display unit 16, on the basis of a detection result of the illuminance sensor 18. Further, in the display system 1, an action of the light-emitting unit 32 in the operation terminal 30 is controlled on the basis of the detection result of the illuminance sensor 18, as will be described later.

The power supply unit 19 is configured to generate various power supply voltages on the basis of, for example, a power supply signal supplied from a commercial power source, and supply these power supply voltages to blocks in the display apparatus 10.

The control unit 21 is configured to control the action of the display apparatus 10 by controlling actions of the blocks of the display apparatus 10. The control unit 21 is configured by using, for example, a processor configured to execute a program. The control unit 21 includes a control information generator 22. The control information generator 22 is configured to generate, on the basis of the detection result of the illuminance sensor 18, the control information INF to be used to control the light emission action of the light-emitting unit 32 in the operation terminal 30. Then, the control unit 21 transmits the control information INF generated by the control information generator 22 to the operation terminal 30, via the wireless communication unit 13.

### (Operation Terminal 30)

The operation terminal 30 is a so-called remote control terminal that controls the action of the display apparatus 10 by remote operation, on the basis of a user's operation. The operation terminal 30 includes an operation unit 31, the light-emitting unit 32, an acceleration sensor 33, an infrared emitter 34, a wireless communication unit 35, a power supply unit 36, and a control unit 37.

The operation unit 31 is configured to accept the user's operation. The operation unit 31 includes a plurality of buttons B. The control unit 37 causes the infrared emitter 34 to transmit an infrared signal, on the basis of the user's operation on the plurality of buttons B.

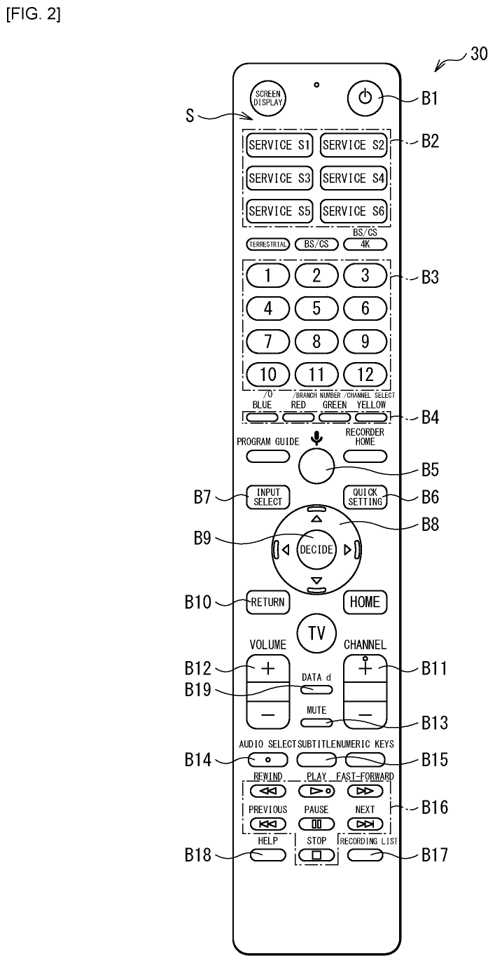

FIG. 2 illustrates a configuration example of the operation terminal 30. The plurality of buttons B are arranged on an operation surface S of the operation terminal 30. The plurality of buttons B include a power button B1, moving-image service selection buttons B2, numeric buttons B3, color buttons B4, a voice assistant call button B5, a setting button B6, an input select button B7, a cursor button B8, a decide button B9, a return button B10, a channel button B11, a volume button B12, a mute button B13, an audio select button B14, a subtitle button B15, moving-image content operation buttons B16, a recording list button B17, a help button B18, and a data broadcast button B19.

The power button B1 is operated in powering on or off the display apparatus 10. The moving-image service selection buttons B2 are operated in selecting moving-image streaming service. In this example, the moving-image service selection buttons B2 include six buttons that correspond to six moving-image streaming services (services S1 to S6) different from each other. The numeric buttons B3 are operated in selecting a channel the user wants to view or in entering a number. In this example, the numeric buttons B3 include 12 buttons. The color buttons B4 are operated in performing a selection operation in, for example, data broadcasting content or an electronic program guide. The voice assistant call button B5 is operated in calling a voice assistant. The setting button B6 is operated in displaying a setting screen for setting of the display apparatus 10. The input select button B7 is operated in selecting a source of video to be displayed out of, for example, the tuner 11, the external equipment coupled to the external equipment interface 14, and the like. The cursor button B8 is operated in moving a cursor in, for example, data broadcasting content or an electronic program guide. The decide button B9 is operated in performing a decision operation. The return button B10 is operated in returning to the previous menu, for example. The channel button B11 is operated in selecting the channel the user wants to view. The volume button B12 is operated in adjusting volume. The mute button B13 is operated for muting. The audio select button B14 is operated in selecting audio in audio multiplex broadcasting content, for example. Specifically, the audio select button B14 is operated in selecting English or Japanese in multilingual content, for example, and is operated in selecting main audio and sub-audio in content including the main audio and the sub-audio. The subtitle button B15 is operated in turning on or off a subtitle display in subtitled content. The moving-image content operation buttons B16 are operated in playing back moving-image content. In this example, the moving-image content operation buttons B16 include a play button, a rewind button, a fast-forward button, a previous button, a next button, a stop button, and a pause button. The recording list button B17 is operated in displaying a list of recorded content in a case where, for example, recording and playback equipment is coupled to the external equipment interface 14. The help button B18 is operated in displaying, for example, help information, such as guidance on an operation method. The data broadcast button B19 is selected in displaying data broadcast in data broadcasting content.

The operation unit 31 thus includes the plurality of buttons B. These buttons B are configured to be highlightable by the light emitted by the light-emitting unit 32 provided on the back of these buttons B. Specifically, the button B may be enabled to be highlighted by, for example, configuring the button B using a translucent material, and by the button B transmitting the light emitted from the light-emitting unit 32. Note that, without being limited thereto, the button B may be enabled to be highlighted by, for example, configuring the button B using a material that does not transmit light, and by the light emitted from the light-emitting unit 32 leaking from a gap around the button B.

The light-emitting unit 32 is configured to highlight the plurality of buttons B in the operation unit 31 by emitting light. The light-emitting unit 32 includes a plurality of light-emitting devices. Light emission actions of the plurality of light-emitting devices are able to be controlled individually, for example. The plurality of light-emitting devices are provided, for example, on the back of the plurality of buttons B. Specifically, the light-emitting unit 32 includes, for example, six light-emitting devices corresponding to the respective six buttons included in the moving-image service selection buttons B2. Thus, by the six light-emitting devices emitting light individually, it is possible for the light-emitting unit 32 to individually highlight these six buttons. Further, for example, the light-emitting unit 32 includes one light-emitting device corresponding to the 12 buttons included in the numeric buttons B3. Thus, by the light-emitting device emitting light, it is possible for the light-emitting unit 32 to collectively highlight these 12 buttons.

The acceleration sensor 33 is configured to detect a motion of the operation terminal 30. Note that, although the acceleration sensor 33 is provided in this example, the present disclosure is not limited thereto. The sensor may be any sensor that is able to detect the motion of the operation terminal 30. Specifically, a gyro sensor may be provided, for example.

The infrared emitter 34 is configured to transmit, to the infrared receiver 12 of the operation terminal 30, an infrared signal that gives an instruction for the action of the display apparatus 10.

The wireless communication unit 35 is configured to exchange information with the wireless communication unit 13 of the display apparatus 10 by using short-range wireless communication. The wireless communication unit 35 receives the control information INF transmitted from the display apparatus 10 to be used to control the light emission action of the light-emitting unit 32, as will be described later.

The power supply unit 36 is configured to supply a voltage supplied from a battery, for example, to blocks in the operation terminal 30. The battery that supplies power to the power supply unit 36 may be a rechargeable battery. The rechargeable battery may be rechargeable by using, for example, wireless power supply, such as Qi (registered trademark).

The control unit 37 is configured to control an action of the operation terminal 30 by controlling actions of the blocks of the operation terminal 30. In addition, the control unit 37 is able to turn an action state of the operation terminal 30 into a sleep state or a normal action state by controlling the actions of the blocks of the operation terminal 30. In the sleep state, for example, the power supply unit 36 stops supplying the voltage to the various blocks, except for the operation unit 31, the acceleration sensor 33, and the control unit 37. The control unit 37 is configured by using, for example, a processor configured to execute a program. The control unit 37 includes a light emission controller 38. The light emission controller 38 is configured to control the light emission action of the light-emitting unit 32 on the basis of the control information INF transmitted from the display apparatus 10.

With this configuration, in the display system 1, the control information generator 22 of the display apparatus 10 generates, on the basis of the detection result of the illuminance sensor 18, control information INF to be used to control the light emission action of the light-emitting unit 32 in the operation terminal 30. Then, the wireless communication unit 13 of the display apparatus 10 transmits the control information INF to the wireless communication unit 35 of the operation terminal 30. The light emission controller 38 of the operation terminal 30 controls the light emission action of the light-emitting unit 32 on the basis of the control information INF. Thus, in the display system 1, in a case where it is dark around the display apparatus 10, for example, it is possible to highlight the operation unit 31 by the light emitted from the light-emitting unit 32. Consequently, it is possible for the user to easily operate the operation terminal 30.

In this example, the operation terminal 30 does not include a network communication unit couplable to the Internet NET, and is configured to be able to transmit information to external equipment or receive information from external equipment by using the infrared emitter 34 or the wireless communication unit 35. Note that, without being limited thereto, the operation terminal 30 may include a network communication unit that is couplable to the Internet NET. In this case, the operation terminal 30 is able to use network communication, thus being able to implement a variety of functions. Further, the operation terminal may be implemented by using, for example, a smartphone or a tablet terminal.

Here, the display apparatus 10 corresponds to a specific example of an “information processing apparatus” according to the present disclosure. The control information generator 22 corresponds to a specific example of a “generator” according to the present disclosure. The control information INF correspond to a specific example of “control information” according to the present disclosure. The wireless communication unit 13 corresponds to a specific example of a “transmitter” according to the present disclosure. The illuminance sensor 18 corresponds to a specific example of an “environment sensor” according to the present disclosure. The operation terminal 30 corresponds to a specific example of an “operation terminal” according to the present disclosure. The operation unit 31 corresponds to a specific example of an “operation unit” according to the present disclosure. The light-emitting unit 32 corresponds to a specific example of a “light-emitting unit” according to the present disclosure. The wireless communication unit 35 corresponds to a specific example of “receiving” according to the present disclosure. The light emission controller 38 corresponds to a specific example of a “controller” according to the present disclosure.

### [Action and Workings]

Next, an action and workings of the display system 1 according to the present embodiment will be described.

### (Overview of Overall Action)

First, an overview of the overall action of the display system 1 will be described with reference to FIG. 1. In the display apparatus 10, the tuner 11 selects a desired video signal from the broadcast waves received by the antenna 9. The infrared receiver 12 receives an infrared signal transmitted from the infrared emitter 34 of the operation terminal 30 and giving an instruction for the action of the display apparatus 10. The wireless communication unit 13 exchanges information with the wireless communication unit 35 of the operation terminal 30 by using short-range wireless communication. The external equipment interface 14 communicates with the external equipment. The network communication unit 15 receives video information through moving-image streaming from a plurality of the content servers 201. The display unit 16 displays video on the basis of, for example, the video signal selected by the tuner 11. The speaker 17 emits sound on the basis of, for example, the video signal selected by the tuner 11. The illuminance sensor 18 detects brightness of the environment around the display apparatus 10. The power supply unit 19 generates various power supply voltages on the basis of, for example, a power supply signal supplied from the commercial power source, and supplies these power supply voltages to the blocks in the display apparatus 10. The control unit 21 controls the action of the display apparatus 10 by controlling the actions of the blocks of the display apparatus 10.

In the operation terminal 30, the plurality of buttons B of the operation unit 31 accept the user's operation. The light-emitting unit 32 highlights the plurality of buttons B in the operation unit 31 by emitting light. The acceleration sensor 33 detects a motion of the operation terminal 30. The infrared emitter 34 transmits, to the infrared receiver 12 of the operation terminal 30, an infrared signal that gives an instruction for the action of the display apparatus 10. The wireless communication unit 35 exchanges information with the wireless communication unit 13 of the display apparatus 10 by using short-range wireless communication. The power supply unit 36 supplies a voltage supplied from the battery, for example, to the blocks in the operation terminal 30. The control unit 37 controls the action of the operation terminal 30 by controlling the actions of the blocks of the operation terminal 30.

The control information generator 22 of the display apparatus 10 generates, on the basis of the detection result of the illuminance sensor 18, control information INF to be used to control the light emission action of the light-emitting unit 32 in the operation terminal 30. The wireless communication unit 13 transmits the control information INF generated by the control information generator 22 to the operation terminal 30. The wireless communication unit 35 of the operation terminal 30 receives the control information INF transmitted from the display apparatus 10. The light emission controller 38 controls the light emission action of the light-emitting unit 32 on the basis of the control information INF.

### (Detailed Action)

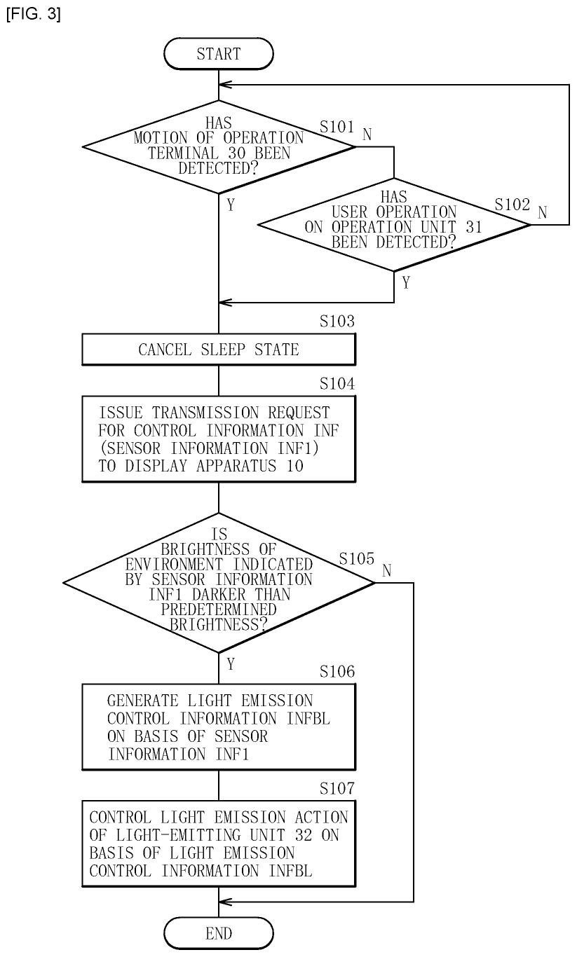

FIG. 3 illustrates an action example of the operation terminal 30. In a case where a motion is detected, or in a case where a user operation on the operation unit 31 is detected, the operation terminal 30 issues a transmission request for control information INF to the display apparatus 10. Then, the operation terminal 30 controls the light emission action of the light-emitting unit 32 on the basis of the control information INF transmitted from the display apparatus 10. The following describes this action in detail.

First, the control unit 37 checks, on the basis of a detection result of the acceleration sensor 33, whether or not a motion of the operation terminal 30 has been detected (step S101). For example, in a case where the user lifts the operation terminal 30 placed on a desk, the control unit 37 detects the motion of the operation terminal 30.

If a motion of the operation terminal 30 has not been detected in step S101 (“N” in step S101), the control unit 37 checks whether or not a user operation on the operation unit 31 has been detected (step S102). For example, in a case where the user operates the button B of the operation terminal 30 placed on a desk, the control unit 37 detects the user operation on the operation unit 31. If a user operation on the operation unit 31 has not been detected (“N” in step S102), this flow returns to step S101, and the control unit 37 repeats steps S101 and S102 until it detects a motion of the operation terminal 30 or detects a user operation on the operation unit 31.

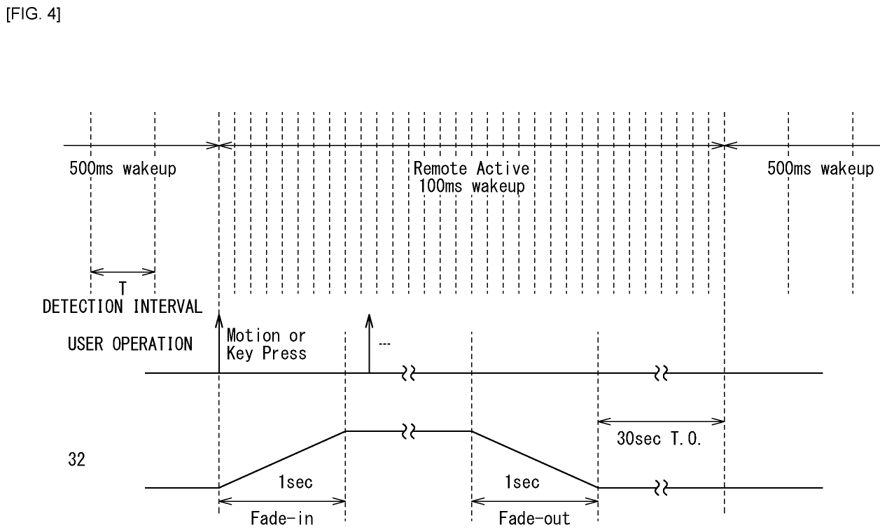

Here, the control unit 37 of the operation terminal 30 may control the acceleration sensor 33 to detect a motion of the operation terminal 30 at predetermined intervals. Further, upon detecting a motion of the operation terminal 30 or a user operation on the operation unit 31, the control unit 37 may detect a motion of the operation terminal 30 at intervals different from those before detecting the motion or the user operation. For example, as illustrated in FIG. 4, the control unit 37 is usually able to detect an acceleration (a motion of the operation terminal 30) at a detection interval T of 500 ms. Further, in a case where the control unit 37 detects a motion of the operation terminal 30 or a user operation on the operation unit 31, the control unit 37 may detect the acceleration at a detection interval T of 100 ms. Then, after the light emission controller 38 causes the light-emitting unit 32 to emit light and ends the light emission, the detection interval T may be returned to 500 ms after a predetermined period of time (e.g., 30 seconds) elapses. Thus, for example, it is possible to suppress a delay before the light-emitting unit 32 emits light after the user lifts the operation terminal 30.

If a motion of the operation terminal 30 has been detected in step S101 (“Y” in step S101) or if a user operation on the operation unit 31 has been detected in step S102 (“Y” in step S102), the control unit 37 changes the action state of the operation terminal 30 from the sleep state to the normal action state (step S103).

Next, the control unit 37 issues, via the wireless communication unit 35, a transmission request for control information INF to the display apparatus 10 (step S104). In this example, the control information INF includes sensor information INF1 indicating the detection result of the illuminance sensor 18. Then, the control unit 37 receives, via the wireless communication unit 35, the control information INF transmitted from the display apparatus 10 in response to the transmission request.

Next, the light emission controller 38 of the control unit 37 checks whether or not the brightness of the environment indicated by the sensor information INF1 included in the control information INF is darker than a predetermined brightness (step S105). If it is brighter than the predetermined brightness (“N” in step S105), this flow ends. That is, in a case where the brightness of the environment is brighter than the predetermined brightness, the user is able to visually recognize the buttons B of the operation unit 31 of the operation terminal 30 easily. Thus, this flow ends without the light emission controller 38 causing the light-emitting unit 32 to emit light.

If the brightness of the environment indicated by the sensor information INF1 is darker than the predetermined brightness in step S105 (“Y” in step S105), the light emission controller 38 generates, on the basis of the sensor information INF1, light emission control information INFBL that gives an instruction for the light emission action of the light-emitting unit 32 (step S106). The light emission control information INFBL includes, for example, information about a start of light emission, an end of light emission, a light emission luminance, light emission time, a light emission cycle, etc. of each of the light-emitting devices of the light-emitting unit 32.

Then, the light emission controller 38 controls the light emission action of the light-emitting unit 32 on the basis of the light emission control information INFBL (step S107). Thus, the operation unit 31 of the operation terminal 30 is highlighted by the light emitted from the light-emitting unit 32.

This is the end of this flow.

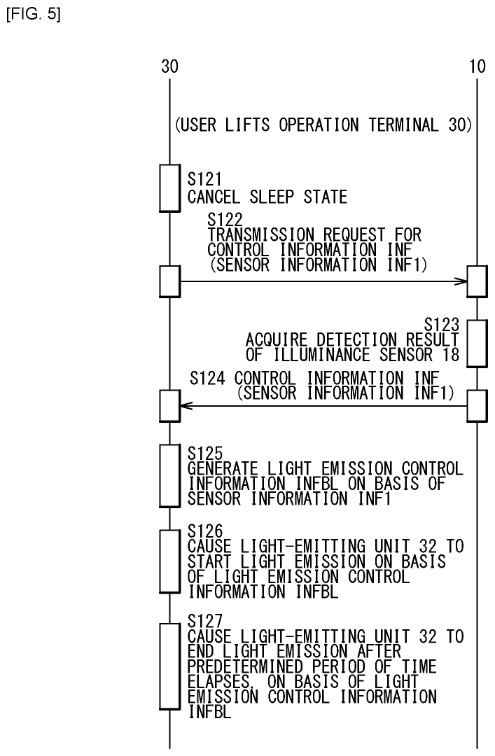

FIG. 5 illustrates an action example of the display system 1 in a case where the user lifts the operation terminal 30 placed on a desk in a dark environment.

When the user lifts the operation terminal 30, the control unit 37 of the operation terminal 30 detects the motion of the operation terminal 30, and changes the action state of the operation terminal 30 from the sleep state to the normal action state (step S121). Then, the control unit 37 issues, to the display apparatus 10 via the wireless communication unit 35, a transmission request for control information INF including sensor information INF1 (step S122). The control unit 21 of the display apparatus 10 receives the transmission request via the wireless communication unit 13.

The control information generator 22 of the display apparatus 10 acquires, in response to the transmission request, the detection result of the illuminance sensor 18 as sensor information INF1 (step S123). In this example, the sensor information INF1 includes information about a brightness of the environment that is darker than the predetermined brightness. Then, the control unit 21 transmits control information INF including the sensor information INF1 to the operation terminal 30 via the wireless communication unit 13 (step S124). The control unit 37 of the operation terminal 30 receives the control information INF via the wireless communication unit 35.

The light emission controller 38 of the operation terminal 30 generates light emission control information INFBL on the basis of the sensor information INF1 included in the control information INF (step S125). That is, in this example, the light emission controller 38 generates the light emission control information INFBL on the basis of the sensor information INF1, because the brightness of the environment is darker than the predetermined brightness. In this example, the light emission control information INFBL is information that gives an instruction to cause all the light-emitting devices in the light-emitting unit 32 to emit light for a predetermined period of time.

Next, the light emission controller 38 causes the light-emitting unit 32 to start light emission on the basis of the light emission control information INFBL (step S126). Thus, the operation unit 31 of the operation terminal 30 is highlighted by the light emitted from the light-emitting unit 32. Then, the light emission controller 38 causes the light-emitting unit 32 to end the light emission after the predetermined period of time elapses, on the basis of the light emission control information INFBL (step S127).

This is the end of this sequence.

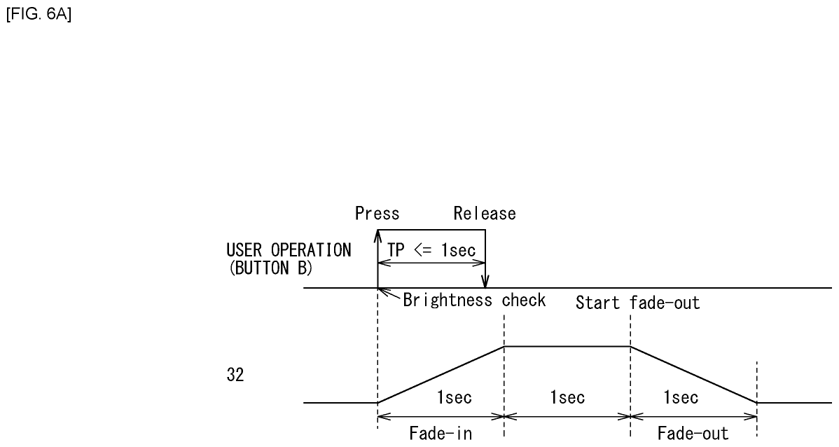

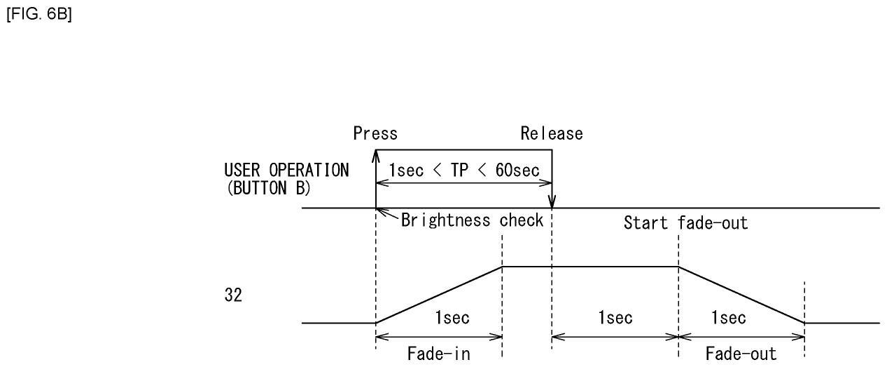

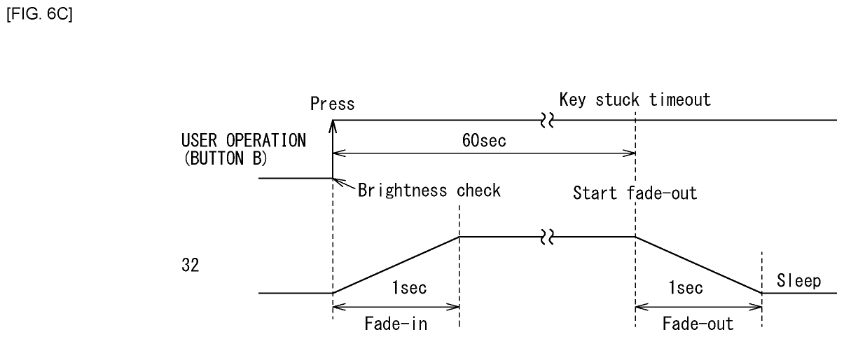

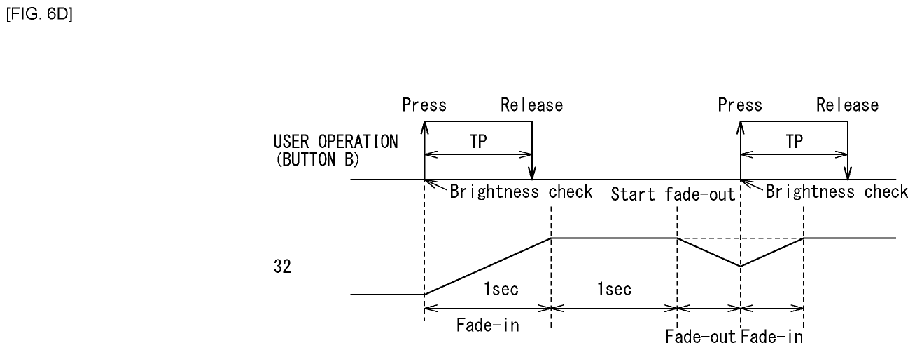

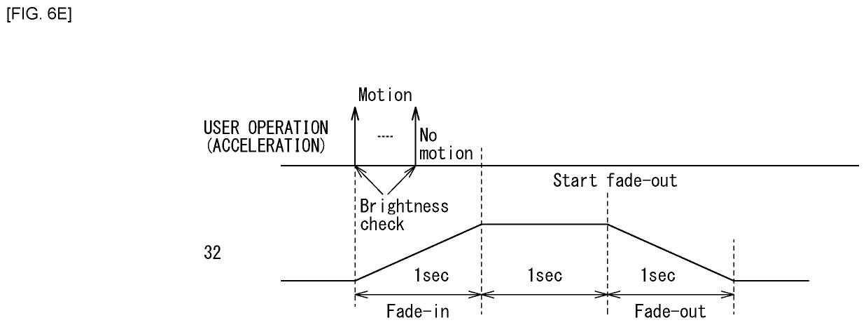

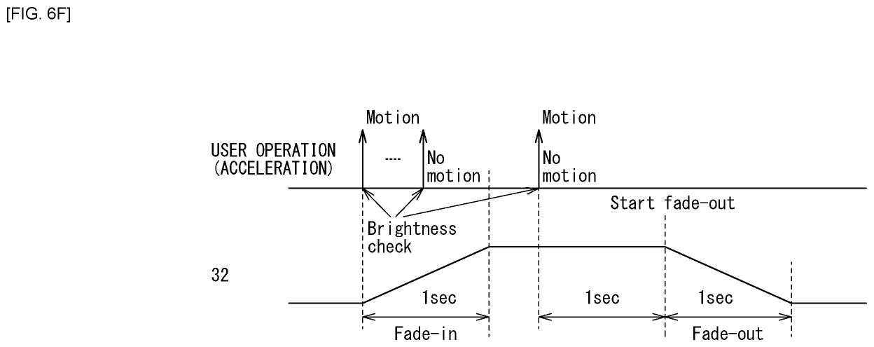

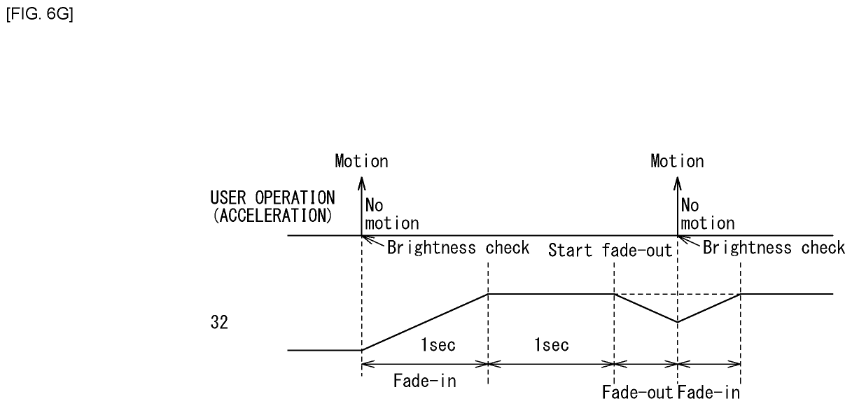

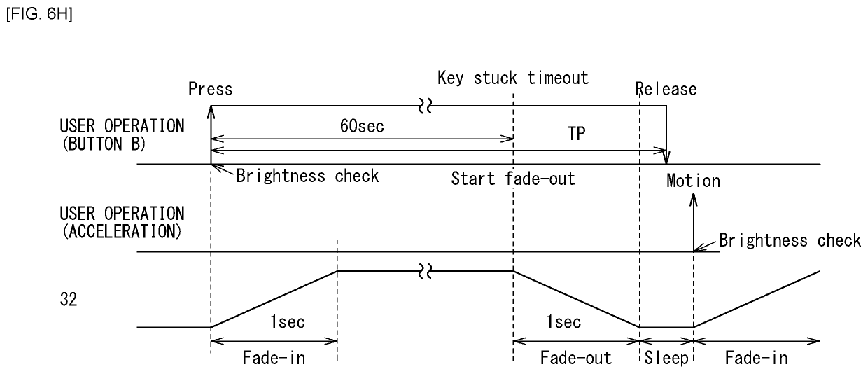

The light emission controller 38 may perform control to change a light emission method of the light-emitting unit 32 at the start of light emission, the end of light emission, or both of the light-emitting unit 32. For example, at the start of light emission and the end of light emission, the light-emitting unit 32 may change luminance gradually from the current luminance to a target luminance, and emit light at a constant luminance after reaching the target luminance. Further, a length of a period in which the luminance changes gradually and a length of a period in which the constant luminance is maintained may each be a predetermined period of time, or may be dynamically changed in accordance with a status of use of the operation terminal 30. FIGS. 6A to 6H illustrate examples of the light emission method of the light-emitting unit 32.

(Case C1, Case where Pressing Time TP of Button B is Short)

In the example of FIG. 6A, in a case where the user operates the operation unit 31, the luminance of the light-emitting unit 32 changes gradually at the start of light emission and the end of light emission. In this example, the user presses the button B. The time from the start of light emission to the end of light emission is set to three seconds, and the light emission time at the target luminance is set to one second. Specifically, the luminance of the light-emitting unit 32 rises gradually from the start of light emission to reach the target luminance one second later, is maintained at a constant luminance for one second, and then falls gradually to become 0 (zero) one second later. For example, in a case where pressing time TP of the button B is sufficiently short (e.g., one second or less), the light-emitting unit 32 emits light for three seconds from the start of light emission to the end of light emission (shutoff) as described above.

(Case C2, Case where Pressing Time TP of Button B is Long)

In the example of FIG. 6B, as in the case of FIG. 6A, the time from the start of light emission to the end of light emission is set to three seconds. In this case, the user presses the button B longer than in the case of FIG. 6A. If the pressing time TP of the button B exceeds one second, the luminance of the light-emitting unit 32 rises gradually to the target luminance in one second and then is maintained at a constant luminance, while the user is pressing the button B. Then, the luminance of the light-emitting unit 32 is maintained at the constant luminance until one second elapses after the user finishes pressing the button B. After one second elapses after the user finishes pressing the button B, the luminance of the light-emitting unit 32 falls gradually to become 0 (zero) one second later.

(Case C3, Case where Pressing Time TP of Button B Exceeds Predetermined Period of Time)

In the example illustrated in FIG. 6C, as in the case of FIG. 6A, the time from the start of light emission to the end of light emission is set to three seconds. In this case, the user presses the button B longer than in the case of FIG. 6B. In a case where the pressing time TP of the button B exceeds one second and further exceeds a predetermined period of time (e.g., 60 seconds), the luminance of the light-emitting unit 32 rises gradually to the target luminance in one second and then is maintained at a constant luminance until a predetermined period of time (e.g., 60 seconds) elapses, while the user is pressing the button B. After this predetermined period of time elapses, the luminance of the light-emitting unit 32 falls gradually to become 0 (zero) one second later.

(Case C4, Case where Button B is Pressed in Course of Ending Light Emission)

In the example of FIG. 6D, in a case where the time from the start of light emission to the end of light emission is set to three seconds, as in the case of FIG. 6A, the user presses the button B again in the course of ending light emission. In this case, the luminance of the light-emitting unit 32 rises gradually to the target luminance from the luminance at a timing when the user presses the button B again. The time from the timing when the button B is pressed until the luminance reaches the target luminance may be the same as the time from the start of a light emission ending action until the button B is pressed. The luminance of the light-emitting unit 32 is maintained for one second after reaching the target luminance again, and then falls gradually to become 0 (zero) one second later. This example describes the case where the user presses the button B again in the course of ending light emission. In a case where the user presses the button B again while the light-emitting unit 32 is maintaining the target luminance, the light-emitting unit 32 may shift to the light emission ending action after one second elapses from the timing when the user presses the button B again.

(Case C5, Case where Acceleration is Detected while Luminance is Rising)

In the example of 6E, as in the case of FIG. 6A, the time from the start of light emission to the end of light emission is set to three seconds. In this example, when light emission starts, the user performs a user operation by moving the operation terminal 30. In a case where an acceleration corresponding to the user operation is thus detected in only a period in which the luminance of the light-emitting unit 32 is increasing (for one second in this example), the light-emitting unit 32 emits light for three seconds from the start of light emission to the end of light emission (shutoff), as in the case of FIG. 6A.

(Case C6, Case where Acceleration is Detected while Luminance is Maintained)

In the example of FIG. 6F, in a case where the time from the start of light emission to the end of light emission is set to three seconds, as in the case of FIG. 6E, an acceleration corresponding to a user operation is further detected in a period in which one second has elapsed from the start of light emission and the light-emitting unit 32 is maintaining the target luminance. In this case, after one second elapses from a timing when the acceleration is detected in the period in which the target luminance is maintained, the luminance of the light-emitting unit 32 falls gradually to become 0 (zero) one second later.

(Case C7, Case where Acceleration is Detected in Course of Ending Light Emission)

In the example of FIG. 6G, in a case where the time from the start of light emission to the end of light emission is set to three seconds, as in the case of FIG. 6E, an acceleration corresponding to a user operation is further detected in the course of ending light emission. In this case, the luminance of the light-emitting unit 32 rises gradually to the target luminance from the luminance at a timing when the acceleration is first detected in the course of ending light emission. The time from the timing when the acceleration is first detected until the luminance reaches the target luminance may be the same as the time from the start of the light emission ending action until the acceleration is first detected.

(Case C8, Case where Acceleration is Detected after Button B is Pressed)

In the example of FIG. 6H, in a case where the time from the start of light emission to the end of light emission is set to three seconds, as in the case of FIG. 6A, the light-emitting unit 32 performs light emission corresponding to detection of an acceleration after light emission corresponding to pressing of the button B. Here, as in the example of FIG. 6C, the user first presses the button B longer than a predetermined period of time (e.g., 60 seconds). Thus, the light-emitting unit 32 performs a light emission process corresponding to the pressing of the button B for 61 seconds in total, and then sets the luminance to 0. Thereafter, in a case where an acceleration caused by the user moving the operation terminal 30 is detected, the light-emitting unit 32 performs the light emission process again. Note that, as illustrated in FIG. 4, in some embodiments, the detection interval T of the acceleration sensor 33 is shorter than usual, until a predetermined period of time (e.g., 30 seconds) elapses from the pressing of the button B or the detection of the acceleration. Therefore, in a case where the light emission corresponding to the detection of the acceleration is performed within a predetermined period of time from the light emission corresponding to the pressing of the button B, response time until the light-emitting unit 32 emits light after the user moves the operation terminal 30 is shorter.

Although the examples of light emission control in the cases C1 to C8 have thus been described by using FIGS. 6A to 6H, the above-described light emission controls are examples, and the present disclosure is not limited to these examples. For example, in the example of case C1, the time from the start of light emission to the change to the target luminance, the time during which the target luminance is maintained, and the time taken to end the light emission are each one second. Without being limited thereto, they may be shorter than one second, or may be longer than one second, for example. Further, the luminance of the light-emitting unit 32 is made to change gradually at both the start of light emission and the end of light emission, but is not limited thereto. For example, the luminance of the light-emitting unit 32 may be made to change gradually only at either one of the start of light emission and the end of light emission. Further, for example, the luminance of the light-emitting unit 32 may be made not to change gradually at both the start of light emission and the end of light emission. In this case, the luminance of the light-emitting unit 32 changes to the target luminance (a constant luminance state or a luminance 0 state) in a short time. Further, the luminance of the light-emitting unit 32 may be made to change to the target luminance in a short time, without changing gradually, only in a case where pressing of the button B is detected or an acceleration is detected in the course of ending light emission.

As described above, in the display system 1, the control information generator 22 of the display apparatus 10 uses the illuminance sensor 18 for adjustment of the display luminance of the display unit 16, to generate control information INF corresponding to the detection result of the illuminance sensor 18. The light emission controller 38 of the operation terminal 30 controls the light emission action of the light-emitting unit 32 on the basis of the control information INF. Thus, in the display system 1, in a case where it is dark around the display apparatus 10, for example, it is possible to highlight the operation unit 31 by the light from the light-emitting unit 32, which enables the user to easily operate the operation terminal 30. Consequently, the display system 1 is able to enhance user's convenience.

Further, in the display system 1, the light emission action of the light-emitting unit 32 is controlled in a case where the brightness of the environment is darker than a predetermined brightness. Thus, the light-emitting unit 32 does not have to emit light in a case where it is bright around the display apparatus 10, which makes it possible to reduce electric power consumption. Consequently, in the display system 1, it is possible to reduce, for example, the number of times of replacing the battery used in the operation terminal 30 and the number of times of charging the battery. This makes it possible to enhance the user's convenience.

Further, in the display system 1, the light emission action of the light-emitting unit 32 is controlled on the basis of the control information INF. Thus, for example, it is possible to cause the light-emitting unit 32 to end the light emission, after a predetermined period of time elapses after causing the light-emitting unit 32 to start the light emission. This makes it possible to restrict the light emission time of the light-emitting unit 32, which makes it possible to reduce electric power consumption. Consequently, in the display system 1, it is possible to reduce, for example, the number of times of replacing the battery used in the operation terminal 30 and the number of times of charging the battery. This makes it possible to enhance the user's convenience.

Further, the display system 1 uses the illuminance sensor 18 provided in the display apparatus 10 to adjust the display luminance of the display unit 16. Thus, it is not necessary to provide an illuminance sensor in the operation terminal 30, which makes it possible to reduce the number of components of the operation terminal 30. Consequently, in the display system 1, it is possible to reduce cost of the operation terminal 30, for example.

### [Effects]

As described above, in the present embodiment, the control information generator of the display apparatus generates control information corresponding to the detection result of the illuminance sensor. The light emission controller of the operation terminal controls the light emission action of the light-emitting unit on the basis of the control information. Thus, in a case where it is dark around the display apparatus, for example, it is possible to highlight the operation unit by the light from the light-emitting unit, which makes it possible to enhance the user's convenience.

In the present embodiment, the light emission action of the light-emitting unit is controlled in a case where the brightness of the environment is darker than a predetermined brightness. This makes it possible to reduce, for example, the number of times of replacing the battery used in the operation terminal and the number of times of charging the battery. This makes it possible to enhance the user's convenience.

In the present embodiment, the light emission action of the light-emitting unit is controlled on the basis of the control information. Thus, for example, it is possible to end the light emission of the light-emitting unit, after a predetermined period of time elapses after starting the light emission of the light-emitting unit. This makes it possible to reduce, for example, the number of times of replacing the battery used in the operation terminal and the number of times of charging the battery. This makes it possible to enhance the user's convenience.

The present embodiment uses the illuminance sensor provided in the display apparatus to adjust the display luminance of the display unit. This makes it possible to reduce the cost of the operation terminal.

### Modification Example 1-1

In the above embodiment, the control information INF includes the sensor information INF1. Without being limited thereto, it may include various information to be used to control the light emission action of the light-emitting unit 32 in the operation terminal 30. The following is a detailed description of an example in which the control information INF includes the light emission control information INFBL that gives an instruction for the light emission action of the light-emitting unit 32.

A display system 1A according to the present modification example includes a display apparatus 10A and an operation terminal 30A, as in the case of the above embodiment (FIG. 1). The display apparatus 10A includes a control unit 21A. The control unit 21A includes a control information generator 22A. The control information generator 22A is configured to generate, on the basis of the detection result of the illuminance sensor 18, the control information INF including the light emission control information INFBL. The operation terminal 30A includes a control unit 37A. The control unit 37A includes a light emission controller 38A. The light emission controller 38A is configured to control the light emission action of the light-emitting unit 32 on the basis of the control information INF including the light emission control information INFBL.

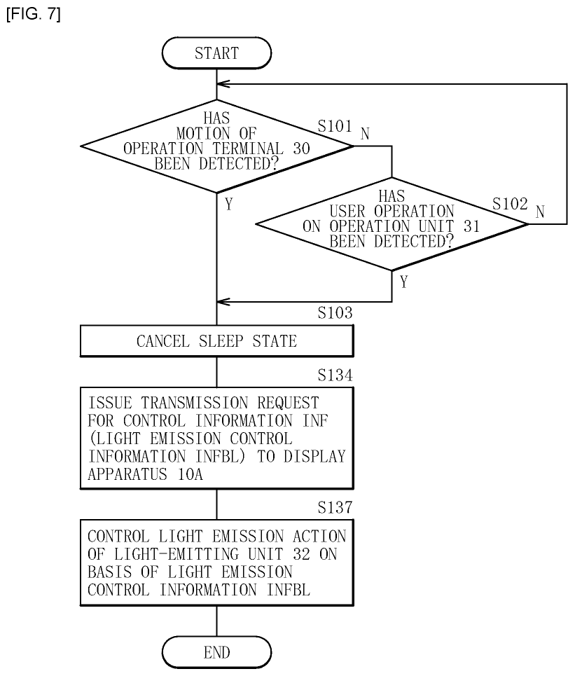

FIG. 7 illustrates an action example of the operation terminal 30A.

First, the control unit 37A checks, on the basis of a detection result of the acceleration sensor 33, whether or not a motion of the operation terminal 30A has been detected (step S101). If a motion of the operation terminal 30A has not been detected (“N” in step S101), the control unit 37A checks whether or not a user operation on the operation unit 31 has been detected (step S102). If a user operation on the operation unit 31 has not been detected (“N” in step S102), this flow returns to step S101.

If a motion of the operation terminal 30A has been detected in step S101 (“Y” in step S101) or if a user operation on the operation unit 31 has been detected in step S102 (“Y” in step S102), the control unit 37A changes the action state of the operation terminal 30A from the sleep state to the normal action state (step S103).

Next, the control unit 37A issues, via the wireless communication unit 35, a transmission request for control information INF to the display apparatus 10A (step S134). In this example, the control information INF includes light emission control information INFBL that gives an instruction for the light emission action of the light-emitting unit 32. Then, the control unit 37A receives, via the wireless communication unit 35, the control information INF transmitted from the display apparatus 10A in response to the transmission request.

Next, the light emission controller 38A of the control unit 37A controls the light emission action of the light-emitting unit 32 on the basis of the light emission control information INFBL included in the control information INF (step S137). Thus, the operation unit 31 of the operation terminal 30A is highlighted by the light emitted from the light-emitting unit 32. This is the end of this flow.

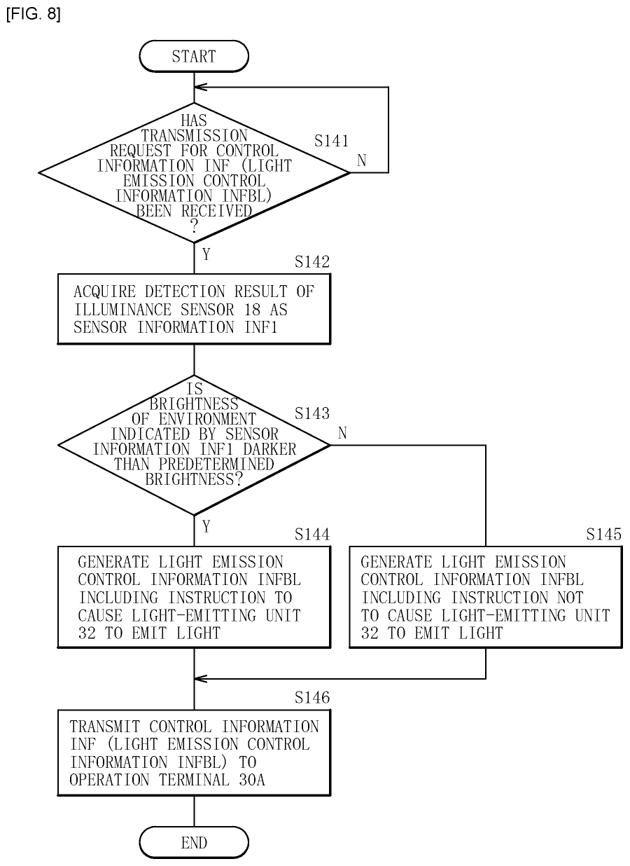

FIG. 8 illustrates an action example of the display apparatus 10A.

First, the display apparatus 10A checks whether or not a transmission request for control information INF including light emission control information INFBL has been received from the operation terminal 30A (step S141). If a transmission request for the control information INF has been received (“Y” in step S141), the control information generator 22A of the control unit 21A acquires the detection result of the illuminance sensor 18 as sensor information INF1 (step S142).

Next, the control information generator 22A checks whether or not the brightness of the environment indicated by the sensor information INF1 is darker than a predetermined brightness (step S143). If it is darker than the predetermined brightness (“Y” in step S143), the control information generator 22A generates, on the basis of this the sensor information INF1, light emission control information INFBL including an instruction to cause the light-emitting unit 32 to emit light (step S144). Further, if it is brighter than the predetermined brightness (“N” in step S143), the control information generator 22A generates, on the basis of the sensor information INF1, light emission control information INFBL including an instruction not to cause the light-emitting unit 32 to emit light (step S145).

Then, the control unit 21A transmits control information INF including the light emission control information INFBL to the operation terminal 30A via the wireless communication unit 13 (step S146). This is the end of this flow.

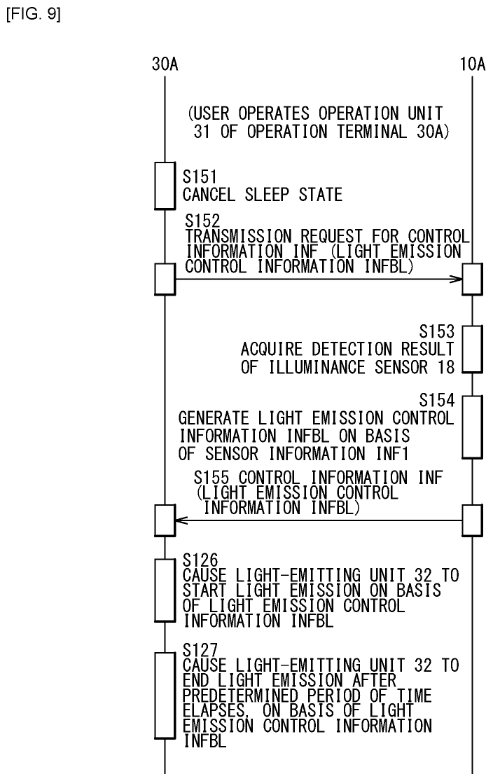

FIG. 9 illustrates an action example of the display system 1A in a case where the user operates the operation unit 31 of the operation terminal 30A placed on a desk in a dark environment.

When the user operates the operation unit 31 of the operation terminal 30A, the control unit 37A of the operation terminal 30A detects the user operation, and changes the action state of the operation terminal 30A from the sleep state to the normal action state (step S151). Then, the control unit 37A issues, to the display apparatus 10A via the wireless communication unit 35, a transmission request for control information INF including light emission control information INFBL (step S152). The wireless communication unit 13 of the display apparatus 10A receives the transmission request.

The control information generator 22A of the display apparatus 10A acquires, in response to the transmission request, the detection result of the illuminance sensor 18 as sensor information INF1 (step S153). In this example, the sensor information INF1 includes information about a brightness of the environment that is darker than the predetermined brightness. Then, the control information generator 22A generates light emission control information INFBL on the basis of the sensor information INF1 (step S154). In this example, because the brightness of the environment is darker than the predetermined brightness, the control information generator 22A generates, on the basis of the sensor information INF1, light emission control information INFBL that gives an instruction to cause all the light-emitting devices in the light-emitting unit 32 to emit light for a predetermined period of time. Then, the control unit 21A transmits control information INF including the light emission control information INFBL to the operation terminal 30A via the wireless communication unit 13 (step S155). The control unit 37A of the operation terminal 30A receives the control information INF via the wireless communication unit 35.

Next, the light emission controller 38A of the operation terminal 30A causes the light-emitting unit 32 to start light emission on the basis of the light emission control information INFBL included in the control information INF (step S126). Thus, the operation unit 31 of the operation terminal 30A is highlighted by the light emitted from the light-emitting unit 32. Then, the light emission controller 38A causes the light-emitting unit 32 to end the light emission after the predetermined period of time elapses, on the basis of the light emission control information INFBL (step S127). This is the end of this sequence.

### Modification Example 1-2

In the above embodiment, in a case where the brightness of the environment indicated by the sensor information INF1 is darker than the predetermined brightness, the light emission controller 38 generates the light emission control information INFBL that gives an instruction to cause all the light-emitting devices in the light-emitting unit 32 to emit light, but is not limited thereto. Alternatively, for example, the light emission controller 38 may generate light emission control information INFBL that gives an instruction to cause all the light-emitting devices in the light-emitting unit 32 to emit light at a higher light emission luminance, as the brightness of the environment indicated by the sensor information INF1 is darker.

### Modification Example 1-3

In the above embodiment, the control information generator 22 generates the control information INF on the basis of the brightness of the environment detected by the illuminance sensor 18, but is not limited thereto. The control information generator may generate the control information INF also on the basis of other parameters about the environment. The following is a detailed description of the present modification example with reference to some examples.

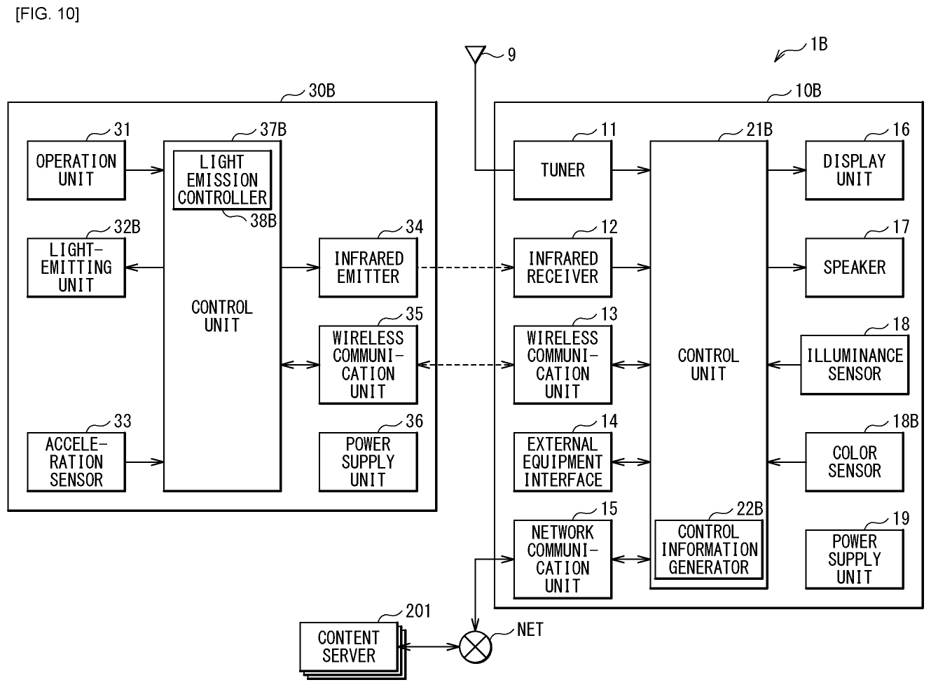

FIG. 10 illustrates a configuration example of a display system 1B according to the present modification example. The display system 1B includes a display apparatus 10B and an operation terminal 30B.

The display apparatus 10B includes a color sensor 18B and a control unit 21B.

The color sensor 18B is configured to detect a color of the environment around the display apparatus 10. Specifically, the color sensor 18B is able to detect, for example, a color of lighting of a room in which the display apparatus 10B is disposed. The control unit 21B adjusts a display color on the display unit 16 on the basis of a detection result of the color sensor 18B. Here, the illuminance sensor 18 and the color sensor 18B correspond to a specific example of the “environment sensor” according to the present disclosure.

The control unit 21B includes a control information generator 22B. The control information generator 22B is configured to generate the control information INF on the basis of the detection result of the illuminance sensor 18 and the detection result of the color sensor 18B. That is, the control information generator 22B generates the control information INF on the basis of the brightness of the environment and the color of the environment.

The operation terminal 30B includes a light-emitting unit 32B and a control unit 37B.

The light-emitting unit 32B is configured to highlight the plurality of buttons B in the operation unit 31 by emitting light. The light-emitting unit 32B includes, for example, a plurality of light-emitting devices. The plurality of light-emitting devices include, for example, a light-emitting device that emits red light, a light-emitting device that emits green light, and a light-emitting device that emits blue light.

The control unit 37B includes a light emission controller 38B. The light emission controller 38B is configured to control the light emission action of the light-emitting unit 32B on the basis of the control information INF transmitted from the display apparatus 10B. Specifically, the light emission controller 38B generates light emission control information INFBL that gives an instruction to cause the light-emitting devices to emit light to make the light-emitting unit 32B emit white light, for example, in a case where the color of the lighting of the room in which the display apparatus 10B is disposed is natural white. Further, the light emission controller 38B generates light emission control information INFBL that gives an instruction to cause the light-emitting devices to emit light to make the light-emitting unit 32B emit warm-colored light, for example, in a case where the color of the lighting of the room in which the display apparatus 10B is disposed is warm white. That is, in this example, the light emission control information INFBL also includes information about a light emission color of the light-emitting unit 32B.

This configuration enables the display system 1B to control the light emission action of the light-emitting unit 32B on the basis of information about the brightness of the environment obtained by the illuminance sensor 18 and information about the color of the environment obtained by the color sensor 18B.

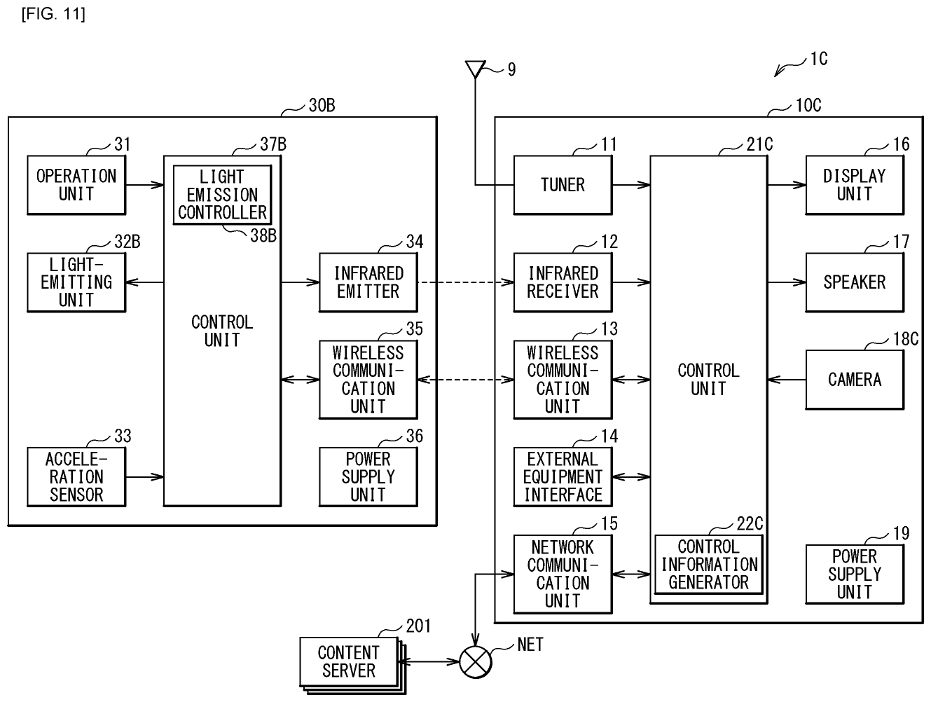

FIG. 11 illustrates a configuration example of another display system 1C according to the present modification example. The display system 1C includes a display apparatus 10C and the operation terminal 30B. The display apparatus 10C includes a camera 18C and a control unit 21C.

The camera 18C is configured to generate a captured image by imaging the user in front of the display apparatus 10C. The display apparatus 10C is able to use the captured image to implement, for example, a function of a videophone. The captured image includes information about the brightness of the environment and the color of the environment. Here, the camera 18C corresponds to a specific example of the “environment sensor” according to the present disclosure.

The control unit 21C includes a control information generator 22C. The control information generator 22C is configured to generate the control information INF on the basis of the captured image obtained by the camera 18C. That is, the control information generator 22B related to the display apparatus 10B (FIG. 10) generates the control information INF on the basis of the information about the brightness of the environment obtained by the illuminance sensor 18 and the information about the color of the environment obtained by the color sensor 18B. In contrast, the control information generator 22C generates the control information INF on the basis of the information about the brightness of the environment and the color of the environment obtained by the camera 18C.

This configuration enables the display system 1C to control the light emission action of the light-emitting unit 32B on the basis of the information about the brightness of the environment and the color of the environment obtained by the camera 18C.

### Modification Example 1-4

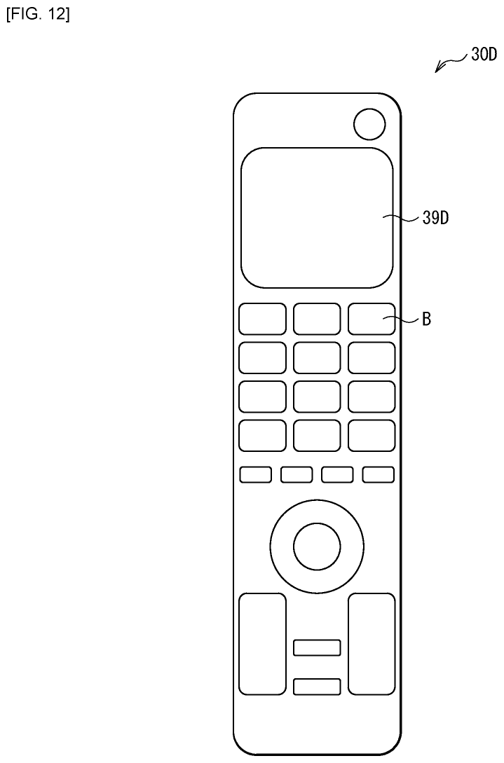

In the above embodiment, the operation terminal 30 includes the plurality of buttons B, as illustrated in FIG. 2, but is not limited thereto. Alternatively, for example, it may further include a display unit 39D in addition to the plurality of buttons B, as in an operation terminal 30D illustrated in FIG. 12. The display unit 39D is configured by using, for example, a liquid crystal display, an organic EL display, or the like. In this case, the light-emitting unit 32 may highlight the plurality of buttons B by emitting light, as in the case of the above embodiment. A light emission controller 38D according to the present modification example may control the light emission action of the light-emitting unit 32 and also control a display action of the display unit 39D, on the basis of the control information INF. Specifically, it is possible for the light emission controller 38D to cause the light-emitting unit 32 to emit light and cause the display unit 39D to display information, for example, on the basis of the control information INF.

Further, for example, the operation terminal may include a touch panel in addition to the display unit, for example. In this case, the user is able to perform an operation by touching a button image displayed on the display unit. The light emission controller is able to control the display action of the display unit to make the display unit display the button image highlighted on the basis of the control information INF. For example, a smartphone may be used as the operation terminal.

### Modification Example 1-5

In the above embodiment, the illuminance sensor 18 is provided in the display apparatus 10. Without being limited thereto, an illuminance sensor may be provided in the operation terminal 30. Then, the light emission controller 38 of the operation terminal 30 may control the light emission action of the light-emitting unit 32, on the basis of the detection result of the illuminance sensor 18 of the display apparatus 10 and a detection result of the illuminance sensor of the operation terminal 30. Further, in a case where using the illuminance sensor provided in the operation terminal 30 makes it possible to control the light emission action without using the illuminance sensor 18 provided in the display apparatus 10, the light emission controller 38 may control the light emission action by using only the detection result of the illuminance sensor in the operation terminal 30. In that case, the illuminance sensor 18 may not be provided in the display apparatus 10.

Similarly, in the display system 1B according to the modification example 1-3 (FIG. 10), for example, the illuminance sensor 18 and the color sensor 18B are provided in the display apparatus 10B. Without being limited thereto, an illuminance sensor and a color sensor may be provided in the operation terminal 30B. Then, the light emission controller 38B may control the light emission action of the light-emitting unit 32, on the basis of the detection result of the illuminance sensor 18 and the color sensor 18B of the display apparatus 10B and a detection result of the illuminance sensor and the color sensor of the operation terminal 30. Further, in a case where using one or both of the illuminance sensor and the color sensor provided in the operation terminal 30B makes it possible to control the light emission action without using one or both of the illuminance sensor 18 and the color sensor 18B provided in the display apparatus 10B, the light emission controller 38B may control the light emission action by using only the detection result of the sensor in the operation terminal 30B. In that case, one or both of the illuminance sensor 18 and the color sensor 18B may not be provided in the display apparatus 10B.

Further, the control unit 21B of the display apparatus 10B may control the action of the display apparatus 10B by receiving, from the operation terminal 30B, environment information (e.g., the brightness of the environment or the color of the environment) acquired by one or both of the illuminance sensor and the color sensor provided on the operation terminal 30B. Specifically, for example, the control unit 21B may adjust the display luminance of the display unit 16 on the basis of information related to the brightness of the environment and acquired by the illuminance sensor of the operation terminal 30B. Further, for example, the control unit 21B may adjust display contrast of the display unit 16 on the basis of information related to the color of the environment and acquired by the color sensor of the operation terminal 30B. Thus using information of the environment sensor provided in the operation terminal 30B makes it possible to acquire environment information that enables the influence due to reflection of light emitted from the display unit 16 of the display apparatus 10B to be reduced. Note that the control of the display apparatus 10B based on the environment sensor of the operation terminal 30B is not limited to the control of the display unit 16, and any setting of the display apparatus 10B may be changed. Further, sensor information transmitted from the environment sensor of the operation terminal 30B to the display apparatus 10B may be information corresponding to the sensor information INF1 or the control information INF.

Further, in a case where an environment sensor, such as an illuminance sensor or a color sensor, is provided in the operation terminal 30B, the power supply unit 36 may supply a power supply voltage to the environment sensor of the operation terminal 30B only in a short period corresponding to a detection timing, on the basis of detection of a motion of the operation terminal 30B or detection of a user operation on the operation unit 31. In addition, in a case where the operation terminal 30B transmits an infrared signal, a transmission timing of the infrared signal and a timing of an illuminance detection process may be shifted from each other, in order to reduce the influence of fluctuations of the infrared signal and the power supply voltage on the illuminance sensor of the operation terminal 30B. Specifically, for example, when the user presses the button B of the operation unit 31, the control unit 37B may detect information related to the brightness of the environment by using the illuminance sensor, and after the detection process by the illuminance sensor ends, may control the infrared emitter 34 to transmit an infrared signal corresponding to the button B to the equipment to be operated, such as the display apparatus 10B.

In addition, the control unit 21B may operate the display apparatus 10B by using the detection result of the acceleration sensor 33 as well as the environment sensor of the operation terminal 30B. Specifically, for example, in a case where it is determined that the operation terminal 30 is turned over, on the basis of the detection result of the illuminance sensor or the acceleration sensor 33 of the operation terminal 30B, the control unit 21B may stop the supply of the power supply voltage to the display unit 16, or may power off the display apparatus 10B. In this case, the display apparatus 10B may receive, from the operation terminal 30B, sensor information indicating that the operation surface S provided with the operation unit 31 and the illuminance sensor is directed downward in a vertical direction, for example.

### Other Modification Examples

In addition, two or more of these modification examples may be combined with each other.

### 2. Second Embodiment

Next, a description will be given on a display system 2 according to a second embodiment. The display system 2 according to the present embodiment is configured to control a light emission action of a light-emitting unit of an operation terminal in accordance with content that is displayed by a display apparatus. Note that substantially the same components as the display system 1 according to the first embodiment are denoted by the same reference numerals, and description thereof will be omitted as appropriate.

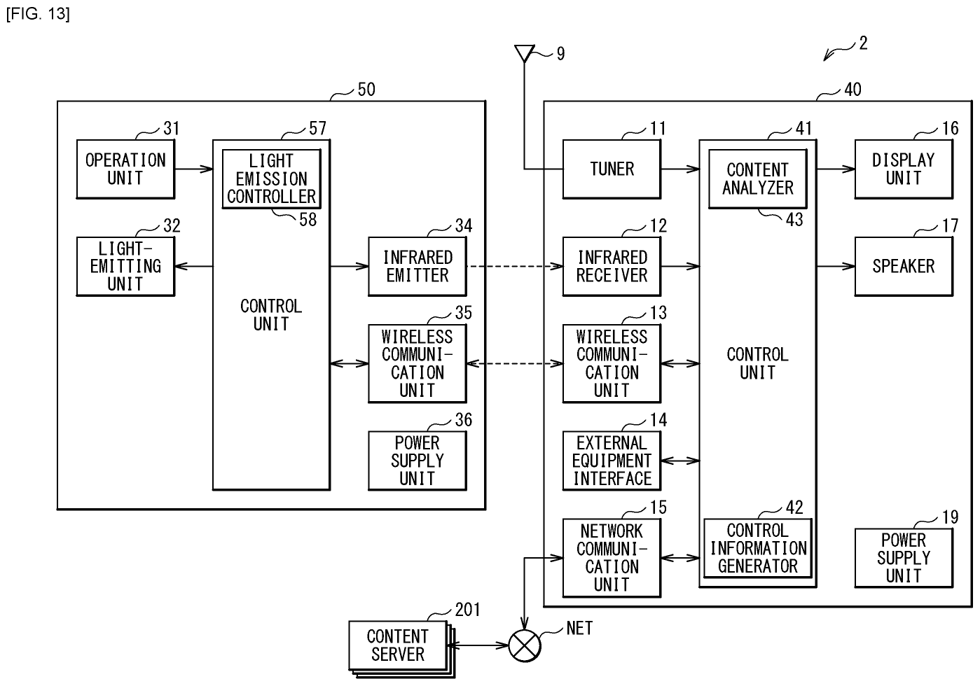

FIG. 13 illustrates a configuration example of the display system 2. The display system 2 includes a display apparatus 40 and an operation terminal 50.

The display apparatus 40 includes a control unit 41. The control unit 41 includes a content analyzer 43 and a control information generator 42.

The content analyzer 43 is configured to analyze content that is displayed by the display unit 16 of the display apparatus 40. Specifically, in a case where the display unit 16 displays video on the basis of, for example, a video signal selected by the tuner 11, the content analyzer 43 analyzes the content by analyzing broadcast metadata included in the video signal.

The control information generator 42 is configured to generate, on the basis of the analysis result of the content analyzer 43, control information INF to be used to control the light emission action of the light-emitting unit 32 in the operation terminal 50. Then, the display apparatus 40 transmits the control information INF generated by the control information generator 42 to the operation terminal 50, via the wireless communication unit 13.

The operation terminal 50 includes a control unit 57. The control unit 57 includes a light emission controller 58. The light emission controller 58 is configured to control the light emission action of the light-emitting unit 32 on the basis of the control information INF transmitted from the display apparatus 40.

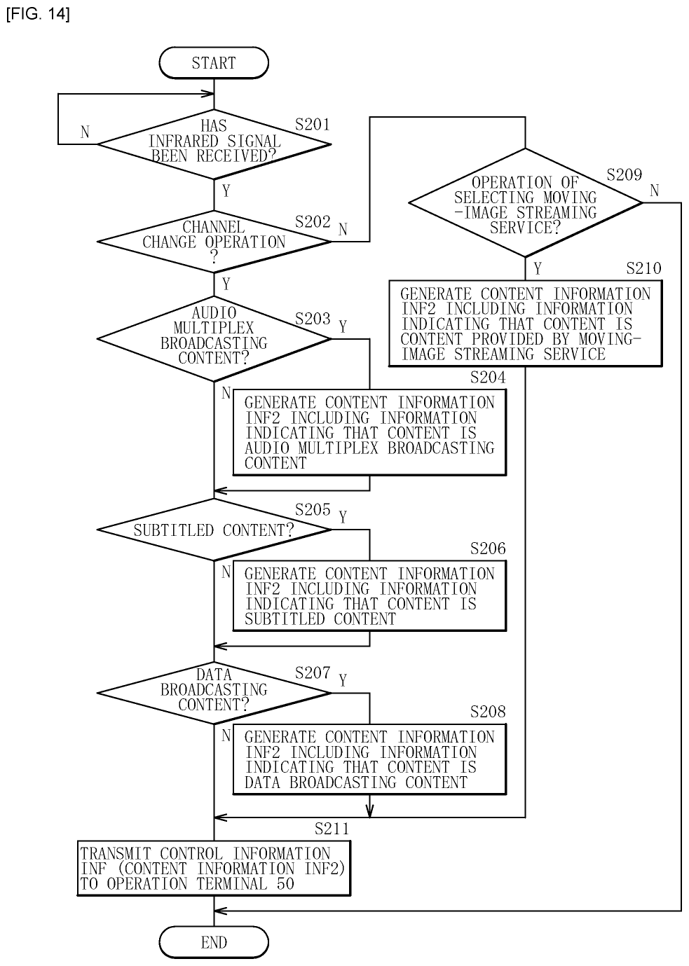

FIG. 14 illustrates an action example of the display apparatus 40.

First, the control unit 41 checks whether or not the infrared receiver 12 has received an infrared signal transmitted from the operation terminal 50 (step S201).

If the infrared receiver 12 has received an infrared signal (“Y” in step S201), the control unit 41 checks whether or not the user has performed a channel change operation (step S202). Specifically, the control unit 41 checks whether or not the user has performed a channel change operation by, for example, checking whether or not the infrared signal is a signal corresponding to an operation on the numeric buttons B3 or the channel button B11 illustrated in FIG. 2.

If the user has performed a channel change operation in step S202 (“Y” in step S202), the content analyzer 43 checks whether or not content being displayed is audio multiplex broadcasting content, on the basis of broadcast metadata included in a video signal corresponding to the channel newly selected by the channel change operation (step S203). Examples of the audio multiplex broadcasting content include multilingual content, and content that includes main audio and sub-audio. If the content being displayed is audio multiplex broadcasting content (“Y” in step S203), the control information generator 42 generates content information INF2 including information indicating that the content being displayed is audio multiplex broadcasting content (step S204).

Next, the content analyzer 43 checks whether or not the content being displayed is subtitled content on the basis of the broadcast metadata (step S205). If the content being displayed is subtitled content (“Y” in step S205), the control information generator 42 generates content information INF2 including information indicating that the content being displayed is subtitled content (step S206).

Next, the content analyzer 43 checks whether or not the content being displayed is data broadcasting content on the basis of the broadcast metadata (step S207). If the content being displayed is data broadcasting content (“Y” in step S207), the control information generator 42 generates content information INF2 including information indicating that the content being displayed is data broadcasting content (step S208). Then, this flow proceeds to step S211.

If the user has not performed a channel change operation in step S202 (“N” in step S201), the control unit 41 checks whether or not the user has performed an operation of selecting moving-image streaming service (step S209). Specifically, the control unit 41 checks whether or not the user has performed an operation of selecting moving-image streaming service by, for example, checking whether or not the infrared signal is a signal corresponding to an operation on the moving-image service selection buttons B2 illustrated in FIG. 2. If the user has not performed an operation of selecting moving-image streaming service (“N” in step S209), this flow ends.

If the user has performed an operation of selecting moving-image streaming service in step S209 (“Y” in step S209), the control information generator 42 generates content information INF2 including information indicating that the content being displayed is content provided by moving-image streaming service (step S210). Then, this flow proceed to step S211.

Then, in a case where the control information generator 42 has generated content information INF2, the control unit 41 transmits control information INF including the content information INF2 to the operation terminal 50, via the wireless communication unit 13 (step S211). This is the end of this flow.

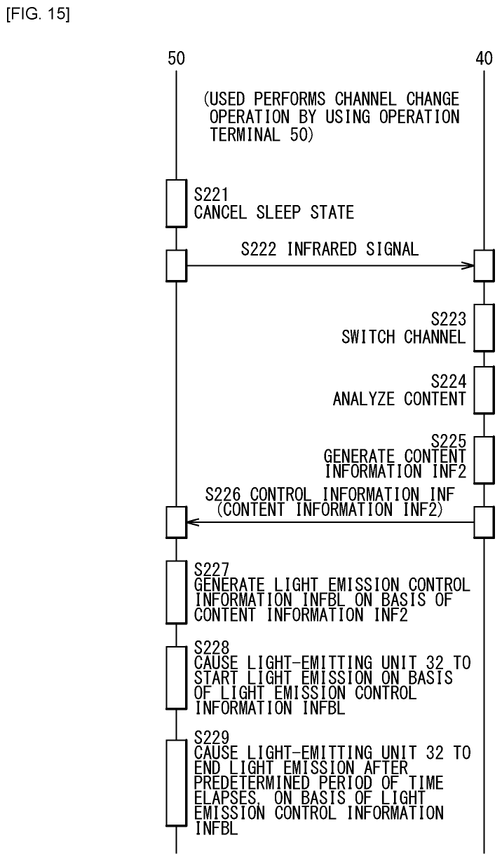

FIG. 15 illustrates an action example of the display system 2 in a case where the user performs a channel change operation.

When the user performs a channel change operation by, for example, operating the numeric buttons B3 or the channel button B11 of the operation terminal 50, the control unit 57 of the operation terminal 50 detects this operation, and changes the action state of the operation terminal 50 from the sleep state to the normal action state (step S221). Then, the infrared emitter 34 transmits an infrared signal corresponding to this channel change operation (step S222). The infrared receiver 12 of the display apparatus 40 receives the infrared signal.

The tuner 11 of the display apparatus 40 switches the channel, on the basis of information about the channel change operation included in the infrared signal (step S223). Then, the content analyzer 43 analyzes content by analyzing broadcast metadata included in a video signal selected by the tuner 11 (step S224). The control information generator 42 generates content information INF2 on the basis of the analysis result of the content analyzer 43 (step S225). Then, the control unit 41 transmits control information INF including the content information INF2 to the operation terminal 50 via the wireless communication unit 13 (step S226). The control unit 57 of the operation terminal 50 receives the control information INF via the wireless communication unit 35.

The light emission controller 58 of the operation terminal 50 generates light emission control information INFBL on the basis of the content information INF2 included in the control information INF (step S227).

For example, in a case where the content information INF2 includes information indicating that the content being displayed is audio multiplex broadcasting content, the light emission controller 58 generates light emission control information INFBL that gives an instruction to cause the light-emitting device, in the light-emitting unit 32, corresponding to the audio select button B14 (FIG. 2) to emit light for a predetermined period of time.

Further, for example, in a case where the content information INF2 includes information indicating that the content being displayed is subtitled content, the light emission controller 58 generates light emission control information INFBL that gives an instruction to cause the light-emitting device, in the light-emitting unit 32, corresponding to the subtitle button B15 (FIG. 2) to emit light for a predetermined period of time.

Further, for example, in a case where the content information INF2 includes information indicating that the content being displayed is data broadcasting content, the light emission controller 58 generates light emission control information INFBL that gives an instruction to cause the light-emitting devices, in the light-emitting unit 32, corresponding to the data broadcast button B19, the color buttons B4, and the numeric buttons B3 (FIG. 2) to emit light for a predetermined period of time. Note that the present disclosure is not limited thereto. For example, in a case where the content being displayed is data broadcasting content, and the content does not accept an operation on the color buttons B4 and the numeric buttons B3, the light emission controller 58 may generate light emission control information INFBL that gives an instruction to cause the light-emitting device corresponding to the data broadcast button B19 to emit light for a predetermined period of time. Further, for example, in a case where the content being displayed is data broadcasting content, and the content accepts an operation on the color buttons B4 and the numeric buttons B3, the light emission controller 58 may generate light emission control information INFBL that gives an instruction to cause the light-emitting devices corresponding to the data broadcast button B19, the color buttons B4, and the numeric buttons B3 to emit light for a predetermined period of time.

Further, for example, in a case where the content information INF2 includes information indicating that the content being displayed is content provided by moving-image streaming service, the light emission controller 58 generates light emission control information INFBL that gives an instruction to cause the light-emitting device, in the light-emitting unit 32, corresponding to the moving-image content operation buttons B16 (FIG. 2) to emit light for a predetermined period of time.

Next, the light emission controller 58 causes the light-emitting unit 32 to start light emission on the basis of the light emission control information INFBL (step S228). Thus, the button B, in the operation unit 31 of the operation terminal 50, indicated by the light emission control information INFBL is highlighted by the light emitted from the light-emitting unit 32. Then, the light emission controller 58 causes the light-emitting unit 32 to end the light emission after the predetermined period of time elapses, on the basis of the light emission control information INFBL (step S229). This is the end of this sequence.

As described above, in the display system 2, the control information generator 42 of the display apparatus 40 generates control information INF corresponding to the content being displayed by the display apparatus 40. The light emission controller 58 of the operation terminal 50 controls the light emission action of the light-emitting unit 32 on the basis of the control information INF. Thus, in the display system 2, it is possible to highlight the button B that is likely to be operated by the user, by the light from the light-emitting unit 32. This enables the user to, for example, easily find the button B the user wants to operate out of the plurality of buttons B. Consequently, the display system 2 is able to enhance user's convenience.

As described above, in the present embodiment, the control information generator of the display apparatus generates control information corresponding to the content being displayed by the display apparatus, and the light emission controller of the operation terminal controls the light emission action of the light-emitting unit on the basis of the control information. This enables the user to, for example, easily find the button the user wants to operate, which makes it possible to enhance the user's convenience. Other effects are similar to those in the case of the first embodiment.

### Modification Example 2-1

In the above embodiment, the control information INF includes the content information INF2. Without being limited thereto, for example, the control information INF may include the light emission control information INFBL that gives an instruction for the light emission action of the light-emitting unit 32, as in the case of the modification example 1-1 of the first embodiment.

### Modification Example 2-2

In the above embodiment, in a case where the content being displayed is audio multiplex broadcasting content, subtitled content, data broadcasting content, or content provided by moving-image streaming service, the button B corresponding to the content is highlighted by the light from the light-emitting unit 32, but the present disclosure is not limited thereto. For example, the corresponding button B may be highlighted for three or less types of content out of these four types of content. Specifically, for example, in a case where the content being displayed is audio multiplex broadcasting content, subtitled content, or content provided by moving-image streaming service, the button B corresponding to the content may be highlighted, and in a case where the content being displayed is data broadcasting content, the corresponding button B may not be highlighted.

### 3. Third Embodiment

Next, a description will be given on a display system 3 according to a third embodiment. The display system 3 according to the present embodiment is configured to analyze video being displayed, and control a light emission action of a light-emitting unit of an operation terminal in accordance with an analysis result. Note that substantially the same components as the display system 1 according to the first embodiment are denoted by the same reference numerals, and description thereof will be omitted as appropriate.

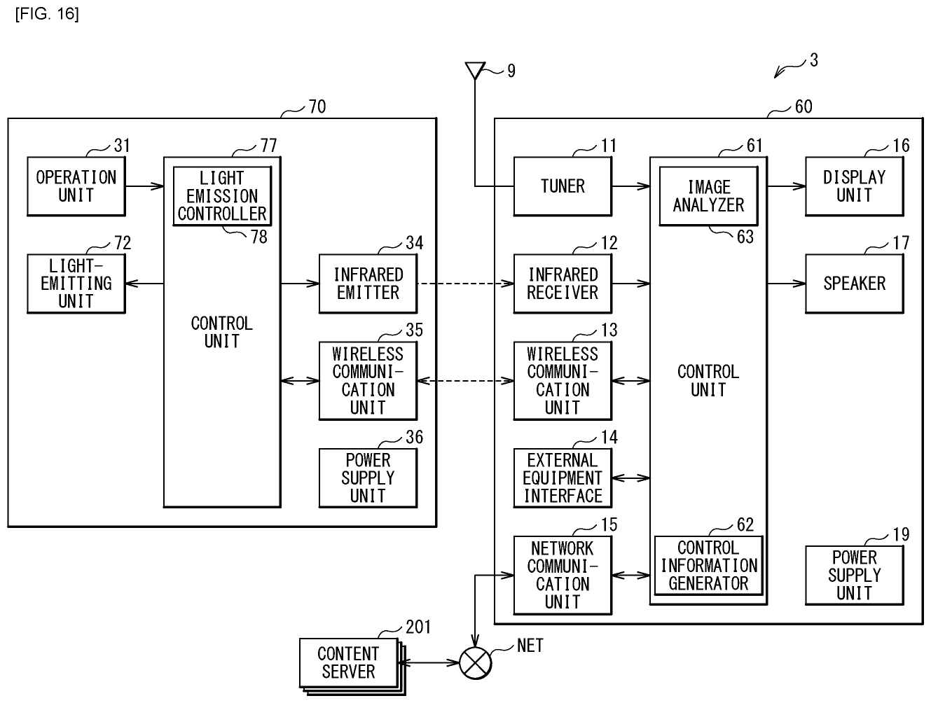

FIG. 16 illustrates a configuration example of the display system 3. The display system 3 includes a display apparatus 60 and an operation terminal 70.

The display apparatus 60 includes a control unit 61. The control unit 61 includes an image analyzer 63 and a control information generator 62.

The image analyzer 63 is configured to analyze an image that is displayed by the display unit 16, on the basis of a video signal. Specifically, the image analyzer 63 generates, on the basis of the video signal, for example, information about an average color of all pixels in a frame image. Note that, although the image analyzer 63 of the display apparatus 60 analyzes the image in this example, the present disclosure is not limited thereto. Alternatively, for example, an external server may analyze the image.

The control information generator 62 is configured to generate, on the basis of the analysis result of the image analyzer 63, control information INF to be used to control a light emission action of a light-emitting unit 72 in the operation terminal 70. Then, the control unit 61 transmits the control information INF generated by the control information generator 62 to the operation terminal 70, via the wireless communication unit 13.

The operation terminal 70 includes the light-emitting unit 72 and a control unit 77.

The light-emitting unit 72 is configured to be able to emit light from the entire surface of the operation surface S. Specifically, it is possible to enable light to be emitted from the operation surface S by, for example, configuring a housing and the button B of the operation terminal 70 using a translucent material, and by the light-emitting unit 72 emitting light. The light-emitting unit 72 includes, for example, a light-emitting device that emits red light, a light-emitting device that emits green light, and a light-emitting device that emits blue light.

The control unit 77 includes a light emission controller 78. The light emission controller 78 is configured to control the light emission action of the light-emitting unit 72 on the basis of the control information INF transmitted from the display apparatus 60.

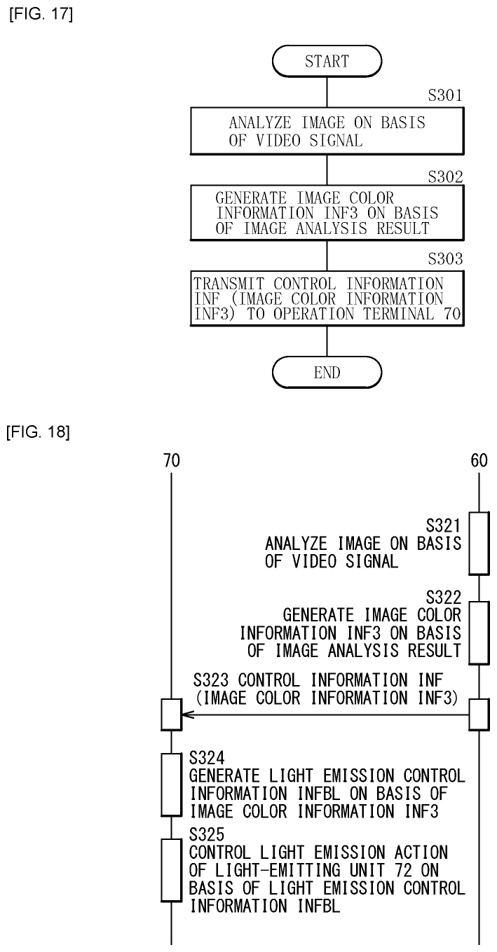

FIG. 17 illustrates an action example of the display apparatus 60. The display apparatus 60 repeatedly performs the following action, each time a predetermined period of time (e.g., about several seconds) elapses.

First, the image analyzer 63 analyzes the image that is displayed by the display unit 16, on the basis of the video signal (step S301).

Next, the control information generator 62 generates image color information INF3 on the basis of the analysis result of the image analyzer 63 (step S302). In this example, the image color information INF3 includes information about the average color in the frame image. The image color information INF3 is representable by using, for example, a luminance signal (Y) and chrominance signals (Cr, Cb). Note that, without being limited thereto, it may be represented by using a red signal (R), a green signal (G), and a blue signal (B).

Then, the control unit 61 transmits control information INF including the image color information INF3 to the operation terminal 70, via the wireless communication unit 13 (step S303). This is the end of this flow.

FIG. 18 illustrates an action example of the display system 3.

The image analyzer 63 of the display apparatus 60 analyzes the image on the basis of the video signal (step S321), and the control information generator 62 generates image color information INF3 on the basis of the image analysis result (step S322). Then, the control unit 61 transmits control information INF including the image color information INF3 to the operation terminal 70 via the wireless communication unit 13 (step S323). The control unit 77 of the operation terminal 70 receives the control information INF via the wireless communication unit 35.

The light emission controller 78 of the operation terminal 70 generates light emission control information INFBL on the basis of the image color information INF3 included in the control information INF (step S324).

For example, in a case where the display unit 16 is displaying a scene where something is burning, the image color information INF3 includes information about red, for example. In this case, the light emission controller 78 generates the light emission control information INFBL by setting the light emission luminance of each of the light-emitting devices to make the light-emitting unit 72 emit red light. Further, for example, in a case where the display unit 16 is displaying a scene of a forest, the image color information INF3 includes information about green, for example. In this case, the light emission controller 78 generates light emission control information INFBL that gives an instruction to cause the light-emitting devices to emit light to make the light-emitting unit 72 emit green light. Further, for example, in a case where the display unit 16 is displaying a scene of an ocean or a scene of the blue sky, the image color information INF3 includes information about blue, for example. In this case, the light emission controller 78 generates light emission control information INFBL that gives an instruction to cause the light-emitting devices to emit light to make the light-emitting unit 72 emit blue light.

Next, the light emission controller 78 controls the light emission action of the light-emitting unit 72 on the basis of the light emission control information INFBL (step S325). Thus, light of the color corresponding to the scene being displayed by the display unit 16 is emitted from the operation surface S of the operation terminal 70.

This is the end of this sequence. By this sequence being repeated, it is possible for the operation terminal 70 to keep emitting light of the color corresponding to the scene being displayed by the display unit 16.

As described above, in the display system 3, the control information generator 62 of the display apparatus 60 generates control information INF corresponding to the color being displayed by the display unit 16. The light emission controller 78 of the operation terminal 70 controls the light emission action of the light-emitting unit 72 on the basis of the control information INF. Thus, the operation terminal 70 is able to emit light of the color corresponding to the scene displayed by the display unit 16, which enables the user viewing content to feel more realism, for example.

As described above, in the present embodiment, the control information generator of the display apparatus generates control information corresponding to the color being displayed by the display unit, and the light emission controller of the operation terminal controls the light emission action of the light-emitting unit on the basis of the control information. This enables the user to feel more realism.

### Modification Example 3-1

In the above embodiment, the control information INF includes the image color information INF3. Without being limited thereto, for example, the control information INF may include the light emission control information INFBL that gives an instruction for the light emission action of the light-emitting unit 72, as in the case of the display system 1A according to the modification example 1-1 of the first embodiment.

### Modification Example 3-2

In the above embodiment, the light-emitting unit 72 that is able to emit light from the entire surface of the operation surface S is provided, but the present disclosure is not limited thereto. For example, the light-emitting unit 32B that is able to highlight the plurality of buttons B in the operation unit 31 by emitting light may be provided, as in the display system 1B according to the modification example 1-3 of the first embodiment. Also in this case, it is possible to emit, from the operation surface S, light of the color corresponding to the scene displayed by the display unit 16, by controlling the light emission luminance of the light-emitting device of each color included in the light-emitting unit 32B.

### 4. Fourth Embodiment

Next, a description will be given on a display system 4 according to a fourth embodiment. The display system 4 according to the present embodiment is configured to, when a display apparatus notifies the user of information, control a light emission action of a light-emitting unit of an operation terminal in accordance with the notification information. Note that substantially the same components as the display system 1 according to the first embodiment are denoted by the same reference numerals, and description thereof will be omitted as appropriate.

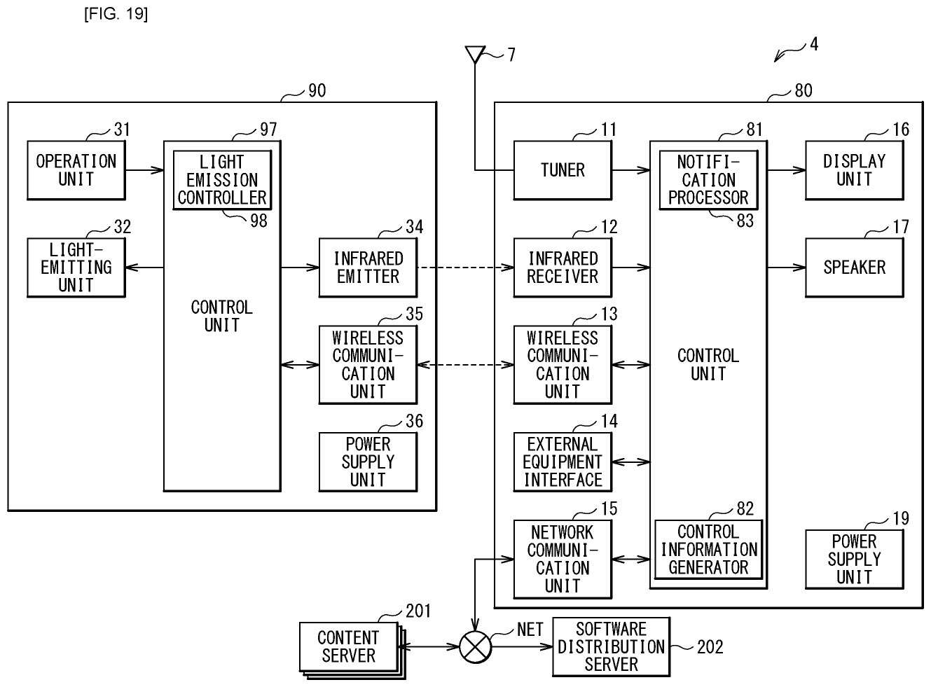

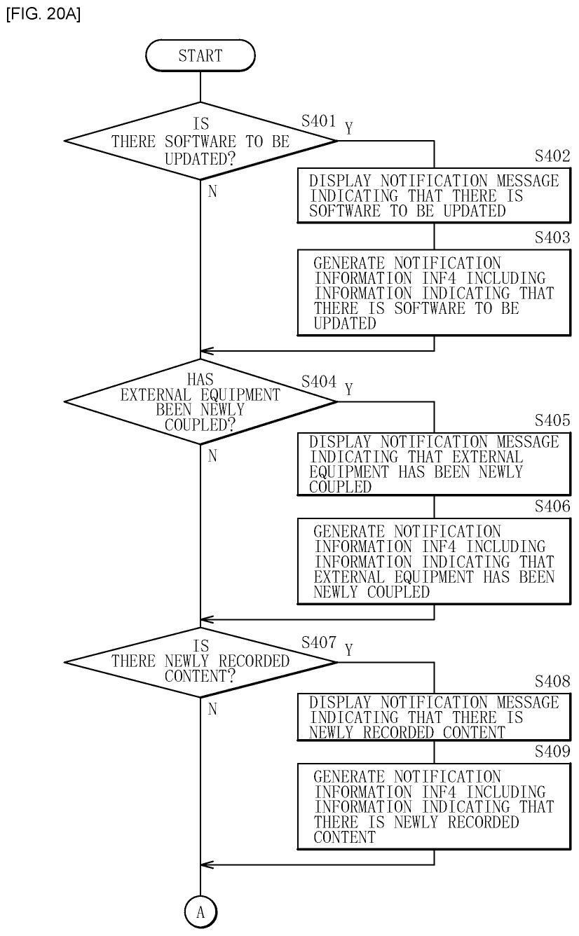

FIG. 19 illustrates a configuration example of the display system 4. The display system 4 includes a display apparatus 80 and an operation terminal 90.

The display apparatus 80 includes a control unit 81. The control unit 81 includes a notification processor 83 and a control information generator 82.

The notification processor 83 is configured to check whether or not there is information of which the user is to be notified, and generate a notification message to be displayed on the display unit 16, for example, in a case where there is information of which the user is to be notified.

The control information generator 82 is configured to generate, on the basis of processing of the notification processor 83, control information INF to be used to control the light emission action of the light-emitting unit 32 in the operation terminal 90. Then, the control unit 81 transmits the control information INF generated by the control information generator 82 to the operation terminal 90, via the wireless communication unit 13.

The operation terminal 90 includes a control unit 97. The control unit 97 includes a light emission controller 98. The light emission controller 98 is configured to control the light emission action of the light-emitting unit 32 on the basis of the control information INF transmitted from the display apparatus 80.

Further, in this example, a software distribution server 202 is coupled to the Internet NET. The software distribution server 202 is configured to deliver software, such as firmware, to the display apparatus 60.

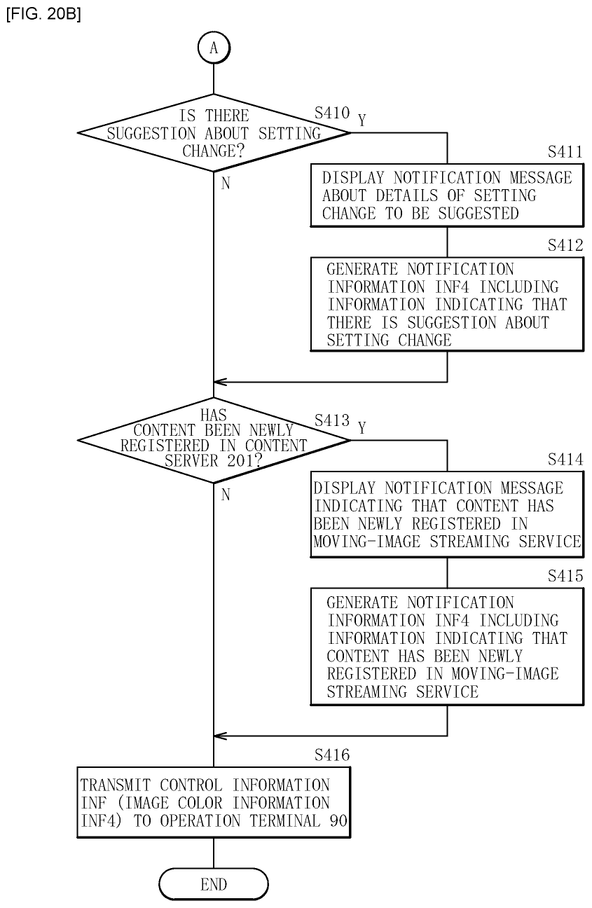

FIGS. 20A and 20B illustrate an action example of the display apparatus 80.

First, the control unit 81 checks whether or not software to be updated has been newly registered in the software distribution server 202 (step S401). If software to be updated has been newly registered (“Y” in step S401), the notification processor 83 generates a notification message indicating that there is software to be updated, and the display unit 16 displays the notification message (step S402). Then, the control information generator 82 generates notification information INF4 including information indicating that there is software to be updated (step S403).

Next, the control unit 81 checks whether or not external equipment has been newly coupled to the external equipment interface 14 (step S404). If external equipment has been newly coupled to the external equipment interface 14, the notification processor 83 generates a notification message indicating that external equipment is newly coupled, and the display unit 16 displays the notification message (step S405). Then, the control information generator 82 generates notification information INF4 including information indicating that external equipment is newly coupled (step S406).

Next, in a case where recording and playback equipment is coupled to the external equipment interface 14, for example, the control unit 81 checks whether or not there is newly recorded content in the recording and playback equipment (step S407). If there is newly recorded content (“Y” in step S407), the notification processor 83 generates a notification message indicating that there is newly recorded content, and the display unit 16 displays the notification message (step S408). Then, the control information generator 82 generates notification information INF4 including information indicating that there is newly recorded content (step S409).

Next, the control unit 81 checks whether or not there is a suggestion to the user about a setting change (step S410). If there is a suggestion about a setting change (“Y” in step S410), the notification processor 83 generates a notification message about details of the setting change to be suggested, and the display unit 16 displays the notification message (step S411). Then, the control information generator 82 generates notification information INF4 including information indicating that is a suggestion about a setting change (step S412).

Next, the control unit 81 checks whether or not content has been newly registered in the content server 201 of moving-image streaming service (step S413). If content has been newly registered (“Y” in step S413), the notification processor 83 generates a notification message indicating that content has been newly registered in the moving-image streaming service, and the display unit 16 displays the notification message (step S414). Then, the control information generator 82 generates notification information INF4 including information indicating that content has been newly registered in the moving-image streaming service (step S415).

Then, the control unit 81 transmits control information INF including the notification information INF4 to the operation terminal 90 via the wireless communication unit 13 (step S416). This is the end of this flow.

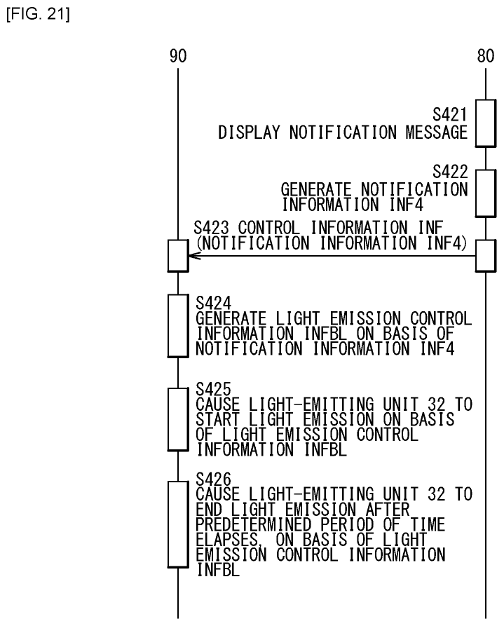

FIG. 21 illustrates an action example of the display system 4.

The notification processor 83 of the display apparatus 80 generates a notification message, and the display unit 16 displays the notification message (step S421). The control information generator 82 generates notification information INF4 on the basis of the processing of the notification processor 83 (step S422). Then, the control unit 81 transmits control information INF including the notification information INF4 to the operation terminal 90 via the wireless communication unit 13 (step S423). The control unit 97 of the operation terminal 90 receives the control information INF via the wireless communication unit 35.

The light emission controller 98 of the operation terminal 90 generates light emission control information INFBL on the basis of the notification information INF4 included in the control information INF (step S424).

For example, in a case where the notification information INF4 includes information indicating that there is software to be updated, the light emission controller 98 generates light emission control information INFBL that gives an instruction to cause the light-emitting device, in the light-emitting unit 32, corresponding to the help button B18 (FIG. 2) to emit light for a predetermined period of time.

Further, for example, in a case where the notification information INF4 includes information indicating that external equipment is newly coupled, the light emission controller 98 generates light emission control information INFBL that gives an instruction to cause the light light-emitting device, in the light-emitting unit 32, corresponding to the input select button B7 (FIG. 2) to emit light for a predetermined period of time.

Further, for example, in a case where the notification information INF4 includes information indicating that there is newly recorded content, the light emission controller 98 generates light emission control information INFBL that gives an instruction to cause the light-emitting device, in the light-emitting unit 32, corresponding to the recording list button B17 (FIG. 2) to emit light for a predetermined period of time.

Further, for example, in a case where the notification information INF4 includes information indicating that there is a suggestion for a setting change, the light emission controller 98 generates light emission control information INFBL that gives an instruction to cause the light-emitting device, in the light-emitting unit 32, corresponding to the setting button B6 (FIG. 2) to emit light for a predetermined period of time.

Further, for example, in a case where the notification information INF4 includes information indicating that content has been newly registered in moving-image streaming service, the light emission controller 98 generates light emission control information INFBL that gives an instruction to cause the light-emitting device, in the light-emitting unit 32, corresponding to the moving-image service selection buttons B2 (FIG. 2) to emit light for a predetermined period of time. Specifically, in a case where content is newly registered in the service S1 out of the moving-image streaming services, for example, the light emission controller 98 may generate light emission control information INFBL that gives an instruction to cause the light-emitting device corresponding to the button B corresponding to the service S1, out of the moving-image service selection buttons B2, to emit light.

Next, the light emission controller 98 causes the light-emitting unit 32 to start light emission on the basis of the light emission control information INFBL (step S425). Thus, the button B, in the operation unit 31 of the operation terminal 90, indicated by the light emission control information INFBL is highlighted by the light emitted from the light-emitting unit 32. Then, the light emission controller 98 causes the light-emitting unit 32 to end the light emission after the predetermined period of time elapses, on the basis of the light emission control information INFBL (step S426). This is the end of this sequence.

As described above, in the display system 4, the control information generator 82 of the display apparatus 80 generates control information INF corresponding to the information of which the user is to be notified. The light emission controller 98 of the operation terminal 90 controls the light emission action of the light-emitting unit 32 on the basis of the control information INF. Thus, in the display system 4, it is possible to highlight the button B that is likely to be operated by the user, by the light from the light-emitting unit 32. This enables the user to, for example, easily find the button B the user wants to operate out of the plurality of buttons B. Consequently, the display system 4 is able to enhance user's convenience.

As described above, in the present embodiment, the control information generator of the display apparatus generates control information corresponding to the information of which the user is to be notified, and the light emission controller of the operation terminal controls the light emission action of the light-emitting unit on the basis of the control information. This enables the user to, for example, easily find the button the user wants to operate, which makes it possible to enhance the user's convenience. Other effects are similar to those in the case of the first embodiment.

### Modification Example 4-1

In the above embodiment, the control information INF includes the notification information INF4. Without being limited thereto, for example, the control information INF may include the light emission control information INFBL that gives an instruction for the light emission action of the light-emitting unit 32, as in the case of the display system 1A according to the modification example 1-1 of the first embodiment.

### Modification Example 4-2

In the above embodiment, the software distribution server 202 distributes the software, but the present disclosure is not limited thereto. For example, a broadcasting station may distribute the software by using digital broadcast waves. In this case, the control unit 81 may check whether or not the software has been updated, on the basis of the software supplied by using the digital broadcast waves.

### Modification Example 4-3

In the above embodiment, the button B, in the operation terminal 90, corresponding to the notification information is highlighted by the light from the light-emitting unit 32 for a predetermined period of time, as illustrated in steps S425 and S426, but the present disclosure is not limited thereto. Alternatively, for example, when the display unit 16 of the display apparatus 80 displays a notification message in step S421, the button B corresponding to the notification message may be highlighted in a period in which the display unit 16 is displaying the notification message.

### Modification Example 4-4

Although the above embodiment describes the information of which the user is to be notified with reference to some examples, the present disclosure is not limited thereto. For example, in a case where content associated with the content viewed by the user is viewable by broadcasting, moving-image streaming service, or the like, the display unit 16 may display a notification message indicating that, and the button B corresponding to the notification message may be highlighted by the light from the light-emitting unit 32.

Specifically, in the display apparatus 80, when the user finishes viewing a broadcasted movie, for example, the notification processor 83 generates a notification message indicating that other movies related to the movie director of the movie are viewable in the service S1 out of the moving-image streaming services, and the display unit 16 displays the notification message. The control information generator 82 generates notification information INF4 corresponding to the notification message, and the control unit 81 transmits control information INF including the notification information INF4 to the operation terminal 90, via the wireless communication unit 13. On the basis of the notification information INF4 included in the control information INF, the operation terminal 90 highlights the button B corresponding to the service S1, out of the moving-image service selection buttons B2, by the light from the light-emitting unit 32.

Further, for example, in a case where the user views an official trailer of a drama via moving-image streaming service, the notification processor 83 creates a notification message indicating that the drama is viewable via VOD (Video On Demand) service of a set top box coupled to the external equipment interface 14, and the display unit 16 displays the notification message. The control information generator 82 generates notification information INF4 corresponding to the notification message, and the control unit 81 transmits control information INF including the notification information INF4 to the operation terminal 90, via the wireless communication unit 13. The operation terminal 90 highlights the input select button B7 by the light from the light-emitting unit 32, on the basis of the notification information INF4 included in the control information INF.

As described above, the display apparatus 80 is able to recommend content to the user by displaying a notification message on the basis of the content viewed by the user. Then, the operation terminal 90 highlights the button B corresponding to a way by which the recommended content is viewable. This enables the user to easily find the button to be operated to view the content, which makes it possible to enhance the user's convenience.

### Modification Example 4-5

In the above embodiment, the light-emitting unit 32 of the operation terminal 90 emits light on the basis of the notification information INF4 transmitted from the display apparatus 80 and associated with content, but the present disclosure is not limited thereto. For example, the notification processor 83 of the display apparatus 80 may generate a notification message in accordance with a status of the battery contained in the operation terminal 90, and the display unit 16 may display the notification message. Specifically, in a state in which a remaining amount of the battery contained in the operation terminal 90 has fallen below a predetermined level, or in a case where the battery contained in the operation terminal 90 is being charged, the operation terminal 90 may transmit information related to such a status of the battery to the display apparatus 80, and the display unit 16 of the display apparatus 80 may display a notification message corresponding to the received information related to the status of the battery. In this case, the notification-related information, such as the information related to the status of the battery, transmitted from the operation terminal 90 to the display apparatus 80 may be information corresponding to the notification information INF4 or the control information INF, or may be information exchanged via the wireless communication unit 35 and the wireless communication unit 13.

Further, the operation terminal 90 may cause the light-emitting unit 32 to emit light in accordance with the status of the contained battery. In that case, in the light emission, one or more buttons B may be highlighted in a predetermined color and at a predetermined timing. Specifically, when the battery remaining amount falls below a predetermined level, the power button B1 may be controlled to blink in red, and when charging of the battery is started, the power button B1 may be highlighted in a color other than red. In this case, a plurality of buttons B (e.g., the power button B1 and the numeric buttons B3) may be highlighted. Further, the display apparatus 80 or the operation terminal 90 may make the highlighted representation of the button B of the operation terminal 90 and the notification message displayed on the display unit 16 correspond to each other. Specifically, the color or timing at which the light-emitting unit 32 emits light and the color or timing of the notification message displayed on the display unit 16 may be made to correspond to each other. In this case, if the battery remaining amount of the operation terminal 90 falls below a predetermined level or if charging of the battery is started, for example, the color and the blinking frequency of the light emission by the light-emitting unit 32 may be controlled to be the same as the color and the blinking frequency of the notification message displayed on the display unit 16. Further, in a case where the battery of the operation terminal 30 is charged by wireless power supply, the operation terminal 90 may transmit, to the display apparatus 80, information related to the light emission of the light-emitting unit 32 or the status of the battery, when placed on a wireless power supply charger.

### 5. Fifth Embodiment

Next, a description will be given on a display system 5 according to a fifth embodiment. The display system 5 according to the present embodiment is configured to, in a case where a plurality of voice assistants are mounted on a display apparatus, control a light emission action of a light-emitting unit of an operation terminal in accordance with the voice assistant selected by the user. Note that substantially the same components as the display system 1 according to the first embodiment are denoted by the same reference numerals, and description thereof will be omitted as appropriate.

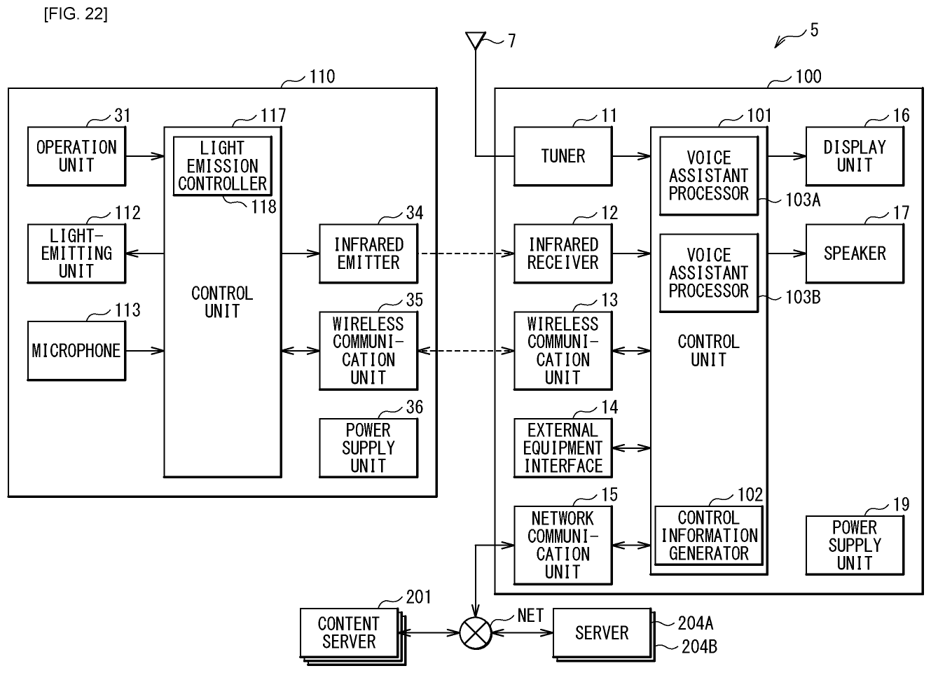

FIG. 22 illustrates a configuration example of the display system 5. The display system 5 includes a display apparatus 100 and an operation terminal 110.

The display apparatus 100 includes a control unit 101. The control unit 101 includes two voice assistant processors 103 (voice assistant processors 103A and 103B) and a control information generator 102.

The voice assistant processor 103 is configured to perform, on the basis of the user's voice data, processing corresponding to the user's instruction included in the voice data. The voice assistant processor 103A implements a function of a voice assistant VA, and the voice assistant processor 103B implements a function of a voice assistant VB. The user selects the voice assistant to be used out of the voice assistants VA and VB by operating the voice assistant call button B5 of the operation terminal 110. The control unit 101 of the display apparatus 100 selects one of the voice assistants VA and VB, on the basis of a button operation code received from the operation terminal 110 via the wireless communication unit 13 and corresponding to the operation on the voice assistant call button B5.

In a case where the button operation code transmitted from the operation terminal 110 indicates the operation of selecting the voice assistant VA by the user, the voice assistant processor 103A transmits voice data subsequently transmitted from the operation terminal 110 to a server 204A coupled to the Internet NET. Then, the voice assistant processor 103A performs processing corresponding to the user's instruction included in the voice data, on the basis of information analyzed by the server 204A.

In a case where the button operation code transmitted from the operation terminal 110 indicates the operation of selecting the voice assistant VB by the user, the voice assistant processor 103B transmits voice data subsequently transmitted from the operation terminal 110 to a server 204B coupled to the Internet NET. Then, the voice assistant processor 103B performs processing corresponding to the user's instruction included in the voice data, on the basis of information analyzed by the server 204B.

The control information generator 102 is configured to generate control information INF to be used to control a light emission action of a light-emitting unit 112 in the operation terminal 110, in accordance with the voice assistant selected by the user, out of the two voice assistants VA and VB. Then, the control unit 101 transmits the control information INF generated by the control information generator 102 to the operation terminal 110, via the wireless communication unit 13.

The operation terminal 110 includes the light-emitting unit 112, a microphone 113, and a control unit 117.

The light-emitting unit 112 is configured to highlight the plurality of buttons B in the operation unit 31 by emitting light. The light-emitting unit 112 includes, for example, a plurality of light-emitting devices. The plurality of light-emitting devices include, for example, a light-emitting device that emits red light, a light-emitting device that emits green light, and a light-emitting device that emits blue light.

The microphone 113 is configured to convert the user's voice, for example, into an electric signal. The control unit 117 generates voice data on the basis of the electric signal supplied from the microphone 113, and transmits the voice data to the display apparatus 100 via the wireless communication unit 35.

In a case where the user operates the voice assistant call button B5 (FIG. 2), for example, the control unit 117 transmits a button operation code via the wireless communication unit 35. The button operation code includes a press code indicating that the voice assistant call button B5 has been pressed, and a release code indicating that the pressed voice assistant call button B5 has been released.

The control unit 117 includes a light emission controller 118. The light emission controller 118 is configured to control the light emission action of the light-emitting unit 112 on the basis of the control information INF transmitted from the display apparatus 100.

Here, the display apparatus 100 corresponds to a specific example of the “information processing apparatus” according to the present disclosure. The control information generator 102 corresponds to a specific example of the “generator” according to the present disclosure. The voice assistant processor 103 corresponds to a specific example of a “voice analyzer” according to the present disclosure.

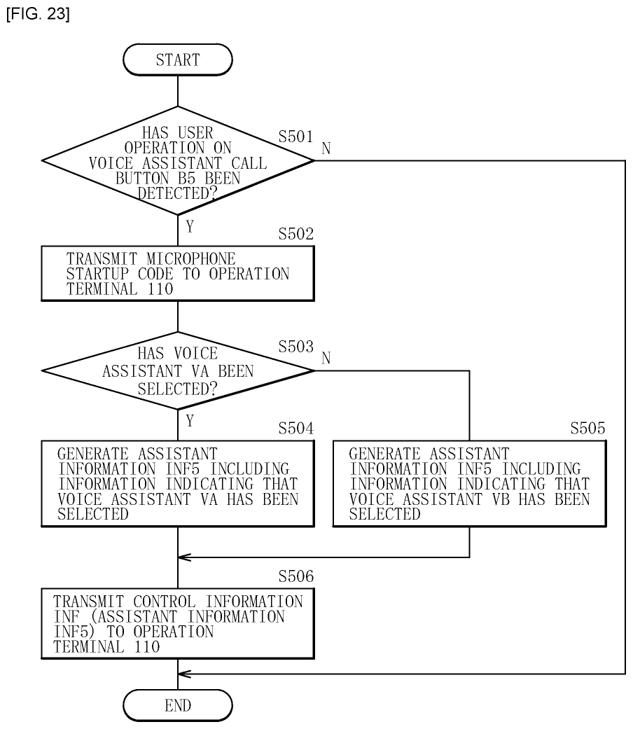

FIG. 23 illustrates an action example of the display apparatus 100.

First, the control unit 101 checks whether or not a user operation on the voice assistant call button B5 has been detected (step S501). For example, in a case of selecting the voice assistant VA, the user presses the voice assistant call button B5 (FIG. 2) in the operation terminal 110 for a short time. In a case of selecting the voice assistant VB, the user presses the voice assistant call button B5 (FIG. 2) for a long time. The control unit 101 selects the voice assistant VA in a case where the button operation code received via the wireless communication unit 13 indicates that the voice assistant call button B5 (FIG. 2) has been pressed for a short time, and selects the voice assistant VB in a case where the button operation code received via the wireless communication unit 13 indicates that the voice assistant call button B5 (FIG. 2) has been pressed for a long time. If a user operation on the voice assistant call button B5 has not been detected (“N” in step S501), this flow ends.

Note that the operation of selecting the voice assistant VA or VB is performed on the basis of the length of time of pressing the voice assistant call button B5 in this example, but is not limited thereto. For example, the operation of selecting the voice assistant VA or VB may be performed on the basis of the number of times of pressing the voice assistant call button B5. For example, the control unit 101 may select the voice assistant VA in a case where the button operation code received via the wireless communication unit 13 indicates that the voice assistant call button B5 has been pressed once, and may select the voice assistant VB in a case where the button operation code received via the wireless communication unit 13 indicates that the voice assistant call button B5 has been pressed twice in succession.

If a user operation on the voice assistant call button B5 has been detected in step S501, the control unit 101 transmits a microphone startup code to the operation terminal 110 via the wireless communication unit 13 (step S502).

Next, it is checked whether or not the voice assistant VA has been selected (step S503). If the voice assistant VA has been selected (“Y” in step S503), the control information generator 102 generates assistant information INF5 including information indicating that the voice assistant VA has been selected (step S504). Further, if the voice assistant VB has been selected (“N” in step S503), the control information generator 102 generates assistant information INF5 including information indicating that the voice assistant VB has been selected (step S505).

Then, the control unit 101 transmits control information INF including the assistant information INF5 to the operation terminal 110 via the wireless communication unit 13 (step S506). This is the end of this flow.

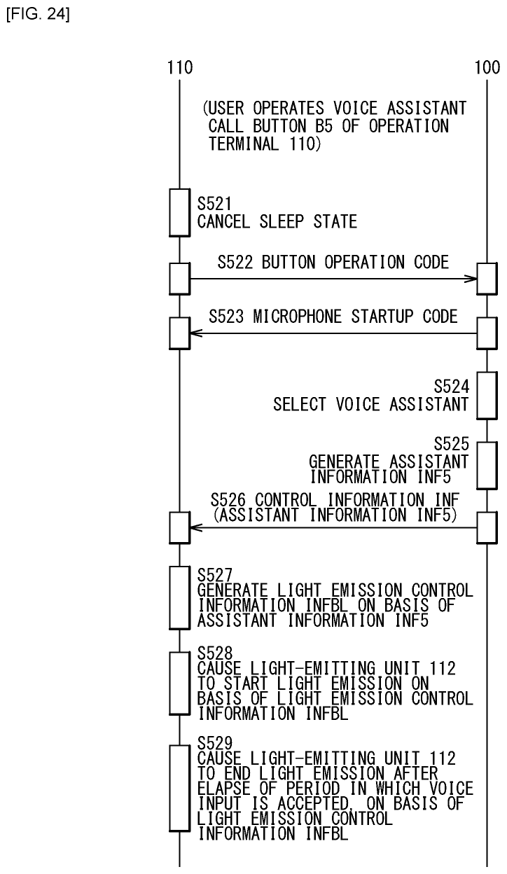

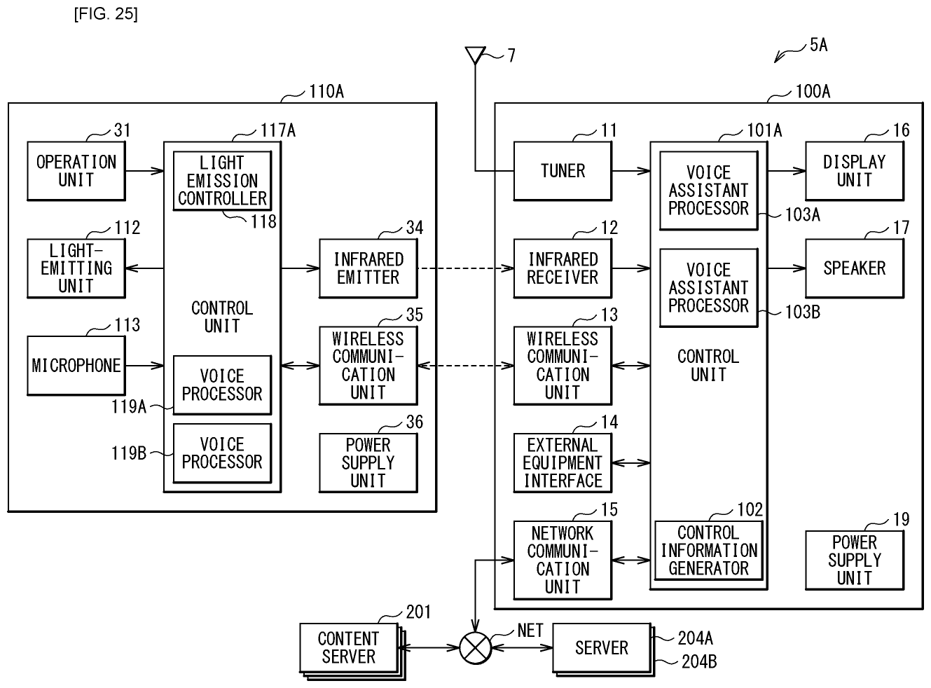

FIG. 24 illustrates an action example of the display system 5 in a case where the user operates the voice assistant call button B5.

When the user operates the voice assistant call button B5 of the operation terminal 110, the control unit 117 of the operation terminal 110 detects this operation, and changes the action state of the operation terminal 110 from the sleep state to the normal action state (step S521). Then, the control unit 117 transmits, via the wireless communication unit 35, a button operation code corresponding to the operation on the voice assistant call button B5 (step S522). The control unit 101 of the display apparatus 100 receives the button operation code via the wireless communication unit 13.

Next, the control unit 101 of the display apparatus 100 transmits a microphone startup code to the operation terminal 110 via the wireless communication unit 13 (step S523). The control unit 117 of the operation terminal 110 receives the microphone startup code via the wireless communication unit 35. The control unit 117 starts up the microphone 113 on the basis of the microphone startup code. The operation terminal 110 thus accepts voice input.

The control unit 101 of the display apparatus 100 selects one of the voice assistants VA and VB, on the basis of information about the operation on the voice assistant call button B5 included in the microphone startup code (step S524). The control information generator 102 generates assistant information INF5 on the basis of a selection result of the voice assistant (step S525). Then, the control unit 101 transmits control information INF including the assistant information INF5 to the operation terminal 110 via the wireless communication unit 13 (step S526). The control unit 117 of the operation terminal 110 receives the control information INF via the wireless communication unit 35.

The light emission controller 118 of the operation terminal 110 generates light emission control information INFBL on the basis of the assistant information INF5 included in the control information INF (step S527).

For example, in a case where the assistant information INF5 includes information indicating that the voice assistant VA has been selected, the light emission controller 118 generates light emission control information INFBL that gives an instruction to cause, in the light-emitting unit 112, the light-emitting devices to emit light to highlight the voice assistant call button B5 (FIG. 2) in orange, for example, for a period in which the voice assistant VA is accepting voice input.

Further, for example, in a case where the assistant information INF5 includes information indicating that the voice assistant VB has been selected, the light emission controller 118 generates light emission control information INFBL that gives an instruction to cause, in the light-emitting unit 112, the light-emitting devices to emit light to highlight the voice assistant call button B5 (FIG. 2) in blue, for example, for a period in which the voice assistant VB is accepting voice input.

Next, the light emission controller 118 causes the light-emitting unit 112 to start light emission on the basis of the light emission control information INFBL (step S528). Thus, the voice assistant call button B5 in the operation unit 31 of the operation terminal 110 is highlighted by the light emitted from the light-emitting unit 112. Then, on the basis of the light emission control information INFBL, the light emission controller 118 causes the light-emitting unit 112 to end the light emission after the period in which the voice assistant accepts voice input ends (step S529). This is the end of this sequence.

As described above, in the display system 5, the control information generator 102 of the display apparatus 100 generates control information INF corresponding to the selected voice assistant. The light emission controller 118 of the operation terminal 110 controls the light emission action of the light-emitting unit 112 on the basis of the control information INF. Thus, the display system 5 enables the user to easily understand the selected voice assistant out of the two voice assistants VA and VB, and to easily understand whether or not the selected voice assistant is accepting voice input. Consequently, the display system 5 is able to enhance user's convenience.

As described above, in the present embodiment, the control information generator of the display apparatus generates control information corresponding to the selected voice assistant, and the light emission controller of the operation terminal controls the light emission action of the light-emitting unit on the basis of the control information. This enables the user to easily understand the selected voice assistant, for example, which makes it possible to enhance the user's convenience. Other effects are similar to those in the case of the first embodiment.

### Modification Example 5-1

In the above embodiment, the control information INF includes the assistant information INF5. Without being limited thereto, for example, the control information INF may include the light emission control information INFBL that gives an instruction for the light emission action of the light-emitting unit 112, as in the case of the display system 1A according to the modification example 1-1 of the first embodiment.

### Modification Example 5-2

In the above embodiment, the voice assistant to be used out of the voice assistants VA and VB is selected by the user operating the voice assistant call button B5, but the present disclosure is not limited thereto. Alternatively, for example, the user may select the voice assistant to be used out of the voice assistants VA and VB by uttering voice assistant call words (call words WA and WB) associated respectively with the voice assistants VA and VB. The following is a detailed description of the present modification example.

FIG. 25 illustrates a configuration example of a display system 5A according to the present modification example. The display system 5A includes a display apparatus 100A and an operation terminal 110A.

The display apparatus 100A includes a control unit 101A. The control unit 101 includes the two voice assistant processors 103 (the voice assistant processors 103A and 103B). The user selects the voice assistant to be used out of the voice assistants VA and VB by uttering the voice assistant call words (the call words WA and WB) associated respectively with the voice assistant processes 103A and 103B, toward the microphone 113 of the operation terminal 110A. The control unit 101A of the display apparatus 100A selects one of the voice assistants VA and VB on the basis of an assistant selection code received from the operation terminal 110A via the wireless communication unit 13 and including information about the voice assistant to be used.

The operation terminal 110A includes a control unit 117A. The control unit 117A performs control to make the microphone 113 accept voice input at all times, unlike the case of the above embodiment. The control unit 117A includes two voice processors 119 (voice processors 119A and 119B). The voice processor 119A generates an assistant selection code that gives an instruction to select the voice assistant VA, in a case where the voice data acquired by the microphone 113 includes the voice assistant call word (call word WA) associated with the voice assistant VA. Similarly, the voice processor 119B generates an assistant selection code that gives an instruction to select the voice assistant VB, in a case where the voice data acquired by the microphone 113 includes the voice assistant call word (call word WB) associated with the voice assistant VB. The control unit 117A transmits the generated assistant selection code to the display apparatus 100A via the wireless communication unit 35.

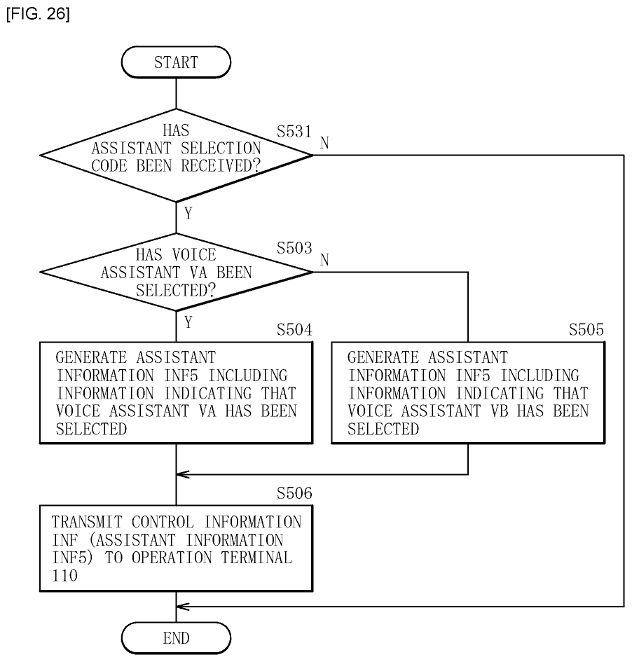

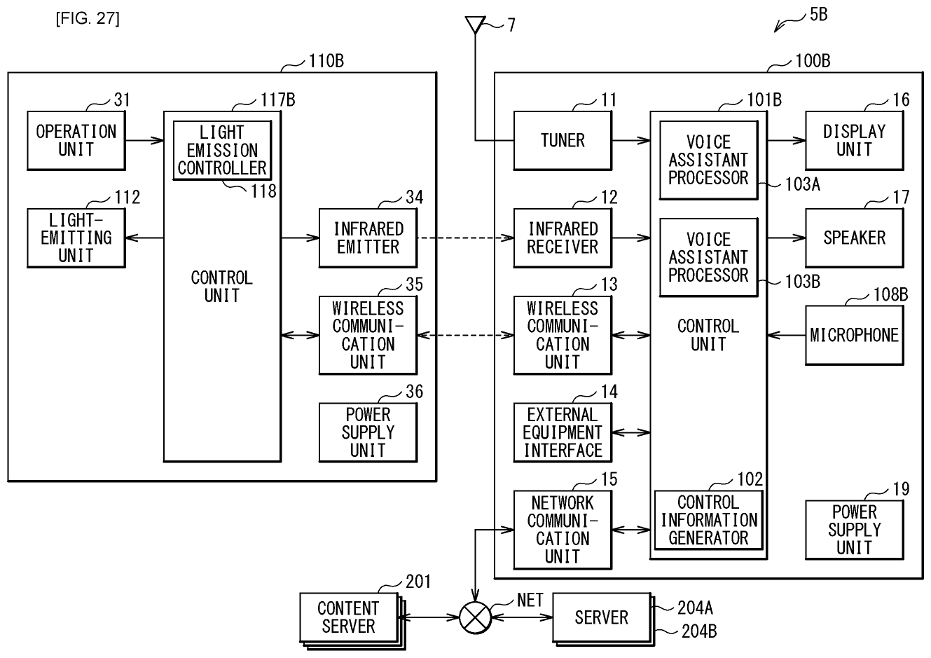

FIG. 26 illustrates an action example of the display apparatus 100A.

First, the control unit 101A checks whether or not an assistant selection code has been received via the wireless communication unit 13 (step S531). If an assistant selection code has not been received (“N” in step S531), this flow ends.

If an assistant selection code has been received in step S531, the control unit 101A checks whether or not the voice assistant VA has been selected (step S503). If the voice assistant VA has been selected (“Y” in step S503), the control information generator 102 generates assistant information INF5 including information indicating that the voice assistant VA has been selected (step S504). Further, if the voice assistant VB has been selected (“N” in step S503), the control information generator 102 generates assistant information INF5 including information indicating that the voice assistant VB has been selected (step S505).

Then, the control unit 101A transmits control information INF including the assistant information INF5 to the operation terminal 110A, via the wireless communication unit 13 (step S506). This is the end of this flow.

### Modification Example 5-3

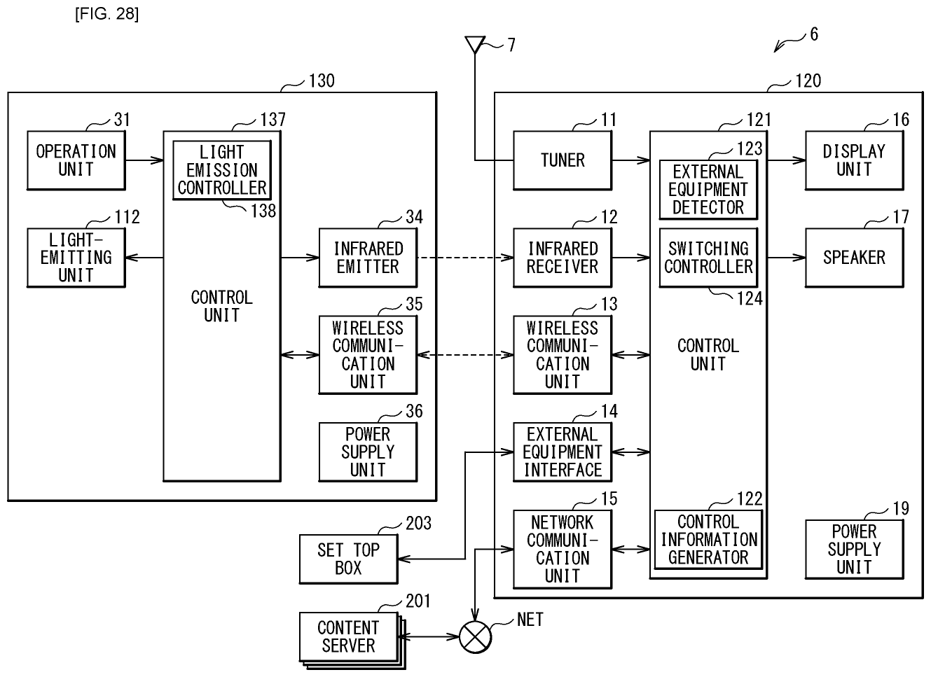

In the above embodiment, the microphone 113 is provided in the operation terminal 110, but is not limited thereto. Alternatively, for example, a microphone may be provided in a display apparatus, as in a display system 5B illustrated in FIG. 27. The display system 5B includes a display apparatus 100B and an operation terminal 110B. The display apparatus 100B includes a microphone 108B and a control unit 101B. The operation terminal 110B includes a control unit 117B. In this example, the control unit 101B of the display apparatus 100B generates voice data on the basis of an electric signal supplied from the microphone 108B of the display apparatus 100B. The control information generator 102 of the display apparatus 100B generates assistant information INF5 including information indicating that the voice assistant VA has been selected in a case where the voice assistant VA has been selected, and generates assistant information INF5 including information indicating that the voice assistant VB has been selected in a case where the voice assistant VB has been selected. The control unit 101B transmits control information INF including the assistant information INF5 to the operation terminal 110B via the wireless communication unit 13.

### Modification Example 5-4

In the above embodiment, the two voice assistant processors 103 are provided in the display apparatus 100, but the present disclosure is not limited thereto. One voice assistant processor may be provided in the display apparatus, and one voice assistant processor may be provided in external equipment coupled to the display apparatus. The external equipment is a smart speaker, for example. The display apparatus and the external equipment are coupled to each other by, for example, a wireless LAN. In this example, the smart speaker generates voice data on the basis of the user's voice, and transmits the voice data to a server coupled to the Internet NET and associated with the smart speaker. The server analyzes the voice data. In a case where the user's instruction included in the voice data is an instruction to operate the display apparatus, the server transmits information about the operation instruction to the display apparatus. In a case where an instruction to operate the display apparatus is received from the server, the voice assistant processor of the display apparatus generates assistant information INF5 including information indicating that the voice assistant of the display apparatus has been selected. Then, the control unit of the display apparatus transmits control information INF including the assistant information INF5 to the operation terminal 110 via the wireless communication unit 13.

### Modification Example 5-5

In the above embodiment, the voice assistant call button B5 (FIG. 2) is highlighted by the light emitted by the light-emitting unit 32 in accordance with the selected voice assistant, but the present disclosure is not limited thereto. Alternatively, for example, all the buttons B in the operation terminal 110 may be highlighted by the light emitted by the light-emitting unit 32 in accordance with the selected voice assistant.

### Modification Example 5-6

In the above embodiment, the action is performed in accordance with the selected voice assistant, but the present disclosure is not limited thereto. For example, in accordance with the user's instruction included in the voice data, the button B related to the instruction may be highlighted by the light emitted by the light-emitting unit 32. For example, in a case where the voice data is an instruction for viewing of content of the service S1, the button B corresponding to the service S1, out of the moving-image service selection buttons B2, may be highlighted by the light emitted by the light-emitting unit 32.

### 6. Sixth Embodiment

Next, a description will be given on a display system 6 according to a sixth embodiment. The display system 6 according to the present embodiment is configured to, in a case where external equipment, such as a set top box, is coupled to a display apparatus, control a light emission action of a light-emitting unit of an operation terminal in accordance with the coupled external equipment. Note that substantially the same components as the display system 1 according to the first embodiment are denoted by the same reference numerals, and description thereof will be omitted as appropriate.

FIG. 28 illustrates a configuration example of the display system 6. The display system 6 includes a display apparatus 120 and an operation terminal 130.

The display apparatus 120 includes a control unit 121. The control unit 121 includes an external equipment detector 123, a switching controller 124, and a control information generator 122. In this example, a set top box 203 is coupled to the external equipment interface 14 of the display apparatus 120.

The external equipment detector 123 is configured to, in a case where external equipment (the set top box 203 in this example) is coupled to the external equipment interface 14, detect that the external equipment is coupled, and acquire information about what type of equipment the external equipment is by communicating with the external equipment via the external equipment interface 14. Types of the external equipment include, for example, a set top box, recording and playback equipment, and playback equipment.

The switching controller 124 is configured to set a source of video to be displayed, on the basis of information about an operation on the input select button B7 included in an infrared signal, and set a target to be controlled by the operation terminal 130, in accordance with the set source. Specifically, assume a case where the set top box 203 coupled to the external equipment interface 14 is set as the source of video to be displayed, for example. In this case, when the user operates, for example, the numeric buttons B3, the cursor button B8, the decide button B9, the channel button B11, the moving-image content operation buttons B16, and the recording list button B17, the switching controller 124 changes the control target based on these user operations to the set top box 203, for example. Thus, in the display system 6, in a case where the display apparatus 120 is displaying video on the basis of a video signal selected by the tuner 11, for example, it is possible for the user to remotely operate the display apparatus 120 by operating the operation unit 31 of the operation terminal 130. In a case where the display apparatus 120 is displaying video on the basis of a video signal supplied from the set top box 203, it is possible for the user to remotely operate the set top box 203 by operating the operation unit 31 of the operation terminal 130.

The control information generator 122 is configured to, in a case where the external equipment coupled to the external equipment interface 14 is selected as the source of video to be displayed by, for example, the user operating the input select button B7, generate control information INF to be used to control the light emission action of the light-emitting unit 32 in the operation terminal 130, in accordance with the external equipment. Then, the control unit 121 transmits the control information INF generated by the control information generator 122 to the operation terminal 130, via the wireless communication unit 13.

The operation terminal 130 includes a control unit 137. The control unit 137 includes a light emission controller 138. The light emission controller 138 is configured to control the light emission action of the light-emitting unit 32 on the basis of the control information INF transmitted from the display apparatus 120.

Here, the display apparatus 120 corresponds to a specific example of the “information processing apparatus” according to the present disclosure. The control information generator 122 corresponds to a specific example of the “generator” according to the present disclosure. The external equipment interface 14 corresponds to a specific example of a “connection unit” according to the present disclosure. The set top box 203 corresponds to a specific example of “external equipment” according to the present disclosure. The external equipment detector 123 corresponds to a specific example of an “acquisition unit” according to the present disclosure.

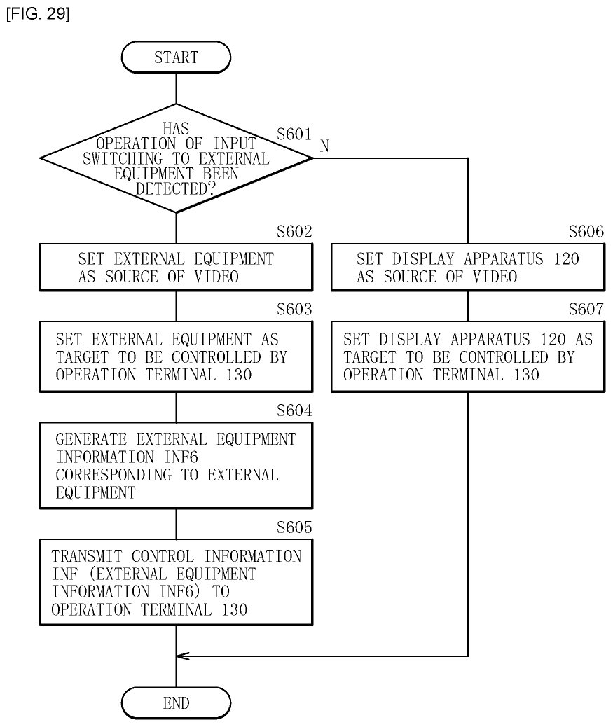

FIG. 29 illustrates an action example of the display apparatus 120. In this example, the set top box 203 has already been coupled to the external equipment interface 14, and the external equipment detector 123 has detected that the set top box 203 is coupled.

First, the control unit 121 checks, for example, whether or not an operation of input switching to the external equipment has been detected (step S601). Specifically, in a case where the infrared signal received by the infrared receiver 12 indicates that the input select button B7 is operated, for example, the control unit 121 checks whether or not the external equipment is selected as the source of video to be displayed, after the input switching.

If an operation of input switching to the external equipment has been detected in step S601 (“Y” in step S601), the switching controller 124 sets the external equipment as the source of video (step S602), and sets the external equipment as the target to be controlled by the operation terminal 130 (step S603).

Next, the control information generator 122 generates, on the basis of a detection result of the external equipment detector 123, external equipment information INF6 corresponding to the coupled external equipment (step S604). Specifically, in a case where a set top box is coupled as the external equipment, for example, the control information generator 122 generates external equipment information INF6 including information indicating that the set top box is coupled.

Then, the control unit 121 transmits control information INF including the external equipment information INF6 to the operation terminal 130, via the wireless communication unit 13 (step S605). Then, this flow ends.

Further, if an operation of input switching to the display apparatus 120 has been detected in step S601 (“N” in step S601), the switching controller 124 sets the display apparatus 120 as the source of video (step S606), and sets the display apparatus 120 as the target to be controlled by the operation terminal 130 (step S607). This is the end of this flow.

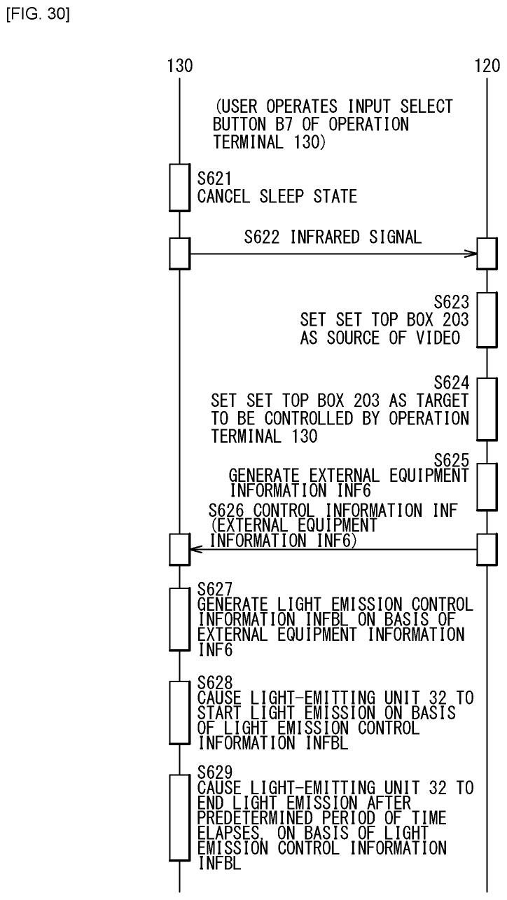

FIG. 30 illustrates an action example of the display system 6 in a case where the set top box 203 is coupled to the display apparatus 120 and input switching to the set top box 203 is performed.

When the user operates the input select button B7 of the operation terminal 110, the control unit 137 of the operation terminal 130 detects this operation, and the control unit 137 changes the action state of the operation terminal 130 from the sleep state to the normal action state (step S621). Then, the infrared emitter 34 transmits an infrared signal corresponding to the operation on the input select button B7 (step S622). The infrared receiver 12 of the display apparatus 120 receives the infrared signal.

On the basis of the information about the operation on the input select button B7 included in the infrared signal, the switching controller 124 of the display apparatus 120 sets the set top box 203 as the source of video (step S623), and sets the set top box 203 as the target to be controlled by the operation terminal 130 (step S624). Then, the control information generator 122 generates, on the basis of the detection result of the external equipment detector 123, external equipment information INF6 including information indicating that the set top box is coupled (step S625). The control unit 121 transmits control information INF including the external equipment information INF6 to the operation terminal 130 via the wireless communication unit 13 (step S626). The control unit 137 of the operation terminal 130 receives the control information INF via the wireless communication unit 35.

The light emission controller 138 of the operation terminal 130 generates light emission control information INFBL on the basis of the external equipment information INF6 included in the control information INF (step S627). In this example, because the external equipment information INF6 includes information indicating that the set top box is coupled, the light emission controller 138 generates light emission control information INFBL that gives an instruction to cause the light-emitting device, in the light-emitting unit 32, corresponding to the button B to be used to view content supplied from the set top box 203 to emit light for a predetermined period of time. Specifically, the light emission controller 138 generates, for example, light emission control information INFBL that gives an instruction to cause the light-emitting devices corresponding to the numeric buttons B3, the cursor button B8, the decide button B9, the return button B10, the channel button B11, the volume button B12, the moving-image content operation buttons B16, and the recording list button B17 to emit light for a predetermined period of time.

Next, the light emission controller 138 causes the light-emitting unit 32 to start light emission on the basis of the light emission control information INFBL (step S628). Thus, the button B, in the operation unit 31 of the operation terminal 130, to be used to view content supplied from the set top box 203 is highlighted by the light emitted from the light-emitting unit 32. Then, the light emission controller 138 causes the light-emitting unit 32 to end the light emission after a predetermined period of time elapses, on the basis of the light emission control information INFBL (step S629). This is the end of this sequence.

As described above, in the display system 6, the control information generator 122 of the display apparatus 120 generates control information INF corresponding to the coupled external equipment. The light emission controller 138 of the operation terminal 130 controls the light emission action of the light-emitting unit 32 on the basis of the control information INF. Thus, the display system 6 enables the user to easily understand the button B usable when viewing the content supplied from the coupled external equipment. Consequently, the display system 6 is able to enhance user's convenience.

As described above, in the present embodiment, the control information generator of the display apparatus generates control information corresponding to the coupled external equipment, and the light emission controller of the operation terminal controls the light emission action of the light-emitting unit on the basis of the control information. This enables the user to easily understand the usable button B, for example, which makes it possible to enhance the user's convenience. Other effects are similar to those in the case of the first embodiment.

### Modification Example 6-1

In the above embodiment, the control information INF includes the external equipment information INF6. Without being limited thereto, for example, the control information INF may include the light emission control information INFBL that gives an instruction for the light emission action of the light-emitting unit 32, as in the case of the display system 1A according to the modification example 1-1 of the first embodiment.

Although the present technology has been described with reference to some embodiments and modification examples, the present technology is not limited to these embodiments and the like, and various modifications may be made.

For example, in the above embodiments, the infrared emitter 34 is provided in the operation terminal, the infrared receiver 12 is provided in the display apparatus, and the action of the display apparatus is controlled by the operation terminal transmitting an infrared signal to the display apparatus, but is not limited thereto. Alternatively, the infrared emitter 34 and the infrared receiver 12 may be omitted, and the operation terminal may control the action of the display apparatus by using communication between the wireless communication unit 35 of the operation terminal and the wireless communication unit 13 of the display apparatus.

For example, the present technology is applied to the display apparatus in the above embodiments, but is not limited thereto. For example, the present technology is applicable to various home electronic equipment, such as a hard disk recorder, a Blu-ray Disc player, a Blu-ray Disc recorder, a set top box, a smart speaker, or a game machine. Specifically, in a case where the present technology is applied to a set top box, the operation terminal may be a remote control terminal that controls the action of the set top box by remote control, on the basis of the user's operation. The display apparatus, for example, a television receiver, is coupled to the set top box. In addition, in a case where the present technology is applied to a game machine, the operation terminal may be a controller of the game machine.

For example, in the above embodiments, the light-emitting device corresponding to the button B is caused to emit light. Without being limited thereto, for example, a light-emitting device not associated with the button B, such as various indicators provided in the operation terminal, may be caused to emit light.

Further, for example, two or more of the above embodiments and modification examples may be combined with each other.

It is to be noted that the effects described in the present specification are merely illustrative and non-limiting, and other effects may be provided.

It is to be noted that the present technology may be configured as below. According to the present technology having the following configurations, it is possible to enhance user's convenience.

(1)

An information processing apparatus including:

a generator configured to generate control information to be used to perform light emission control of a light-emitting unit provided in an operation terminal; and

a transmitter configured to transmit the control information to the operation terminal.

(2)

The information processing apparatus according to (1), in which the light emission control includes controlling one or more of a start of light emission, an end of light emission, a light emission luminance, a light emission color, light emission time, and a light emission cycle.

(3)

The information processing apparatus according to (1) or (2), further including an environment sensor configured to detect an environment of the information processing apparatus, in which

the generator is configured to generate the control information on the basis of a detection result of the environment sensor.

(4)

The information processing apparatus according to (3), in which the environment sensor includes a sensor configured to detect brightness of the environment.

(5)

The information processing apparatus according to (4), in which the light-emitting unit is configured to emit light in a case where the brightness is darker than a predetermined brightness, on the basis of the control information.

(6)

The information processing apparatus according to (4), in which the light-emitting unit is configured to, on the basis of the control information, emit light at a first luminance in a case where the brightness is a first brightness, and emit light at a second luminance that is brighter than the first luminance in a case where the brightness is a second brightness that is darker than the first brightness.

(7)

The information processing apparatus according to any one of (3) to (6), in which the control information includes the detection result of the environment sensor.

(8)

The information processing apparatus according to (1) or (2), in which the generator is configured to generate the control information on the basis of content that is a processing target of the information processing apparatus.

(9)

The information processing apparatus according to (8), further including a content analyzer, in which

the content includes metadata,

the content analyzer is configured to analyze the metadata, and

the generator is configured to generate the control information on the basis of an analysis result of the content analyzer.

(10)

The information processing apparatus according to (8), in which

the content includes image information, and

the generator is configured to generate the control information on the basis of an analysis result of the image information.

(11)

The information processing apparatus according to (1) or (2), in which the generator is configured to generate the control information on the basis of notification information to a user.

(12)

The information processing apparatus according to (11), further including a notification processor configured to generate the notification information, in which

the control information includes information that causes the light-emitting unit to emit light to correspond to a button associated with the notification information presented to the user, out of a plurality of buttons included in the operation terminal.

(13)

The information processing apparatus according to (1) or (2), further including a voice processor configured to process voice information accepted from a user, in which

the generator is configured to generate the control information on the basis of processing of the voice processor.

(14)

The information processing apparatus according to (13), in which

the voice processor includes a plurality of processors, and is configured to select one of the plurality of processors in response to an operation of the user, and

the control information includes information corresponding to the processor selected out of the plurality of processors.

(15)

The information processing apparatus according to (1) or (2), further including:

a connection unit couplable to external equipment; and

an acquisition unit that acquires information related to a function of the external equipment, in which

the generator is configured to generate the control information on the basis of the information related to the function of the external equipment.

(16)

The information processing apparatus according to (15), in which the control information includes information that causes the light-emitting unit to emit light to correspond to a button associated with an operation on the external equipment, out of a plurality of buttons included in the operation terminal.

(17)

An operation terminal including:

an operation unit configured to accept an operation of a user;

a light-emitting unit configured to emit light from an operation surface of the operation unit;

a receiver configured to receive control information transmitted from an information processing apparatus; and

a controller configured to perform light emission control of the light-emitting unit on the basis of the control information.

(18)

The operation terminal according to (17), in which the control information includes information corresponding to a detection result of an environment sensor provided in the information processing apparatus and configured to detect an environment of the information processing apparatus.

(19)

The operation terminal according to (17), in which the control information includes information corresponding to processing of a voice processor provided in the information processing apparatus and configured to process voice information.

(20)

An information processing method including:

generating, by an information processing apparatus, control information to be used to perform light emission control of a light-emitting unit provided in an operation terminal;

transmitting, by the information processing apparatus, the control information to the operation terminal; and

performing, by the operation terminal, the light emission control of the light-emitting unit on the basis of the control information transmitted from the information processing apparatus.

This application claims the benefit of Japanese Priority Patent Application No. 2019-100957 filed with the Japan Patent Office on May 30, 2019, and Japanese Priority Patent Application No. 2019-235744 filed with the Japan Patent Office on Dec. 26, 2019, the entire contents of each of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An information processing apparatus comprising:
a generator configured to generate control information to be used to perform light emission control of a light-emitting unit provided in an operation terminal; and
a transmitter configured to transmit the control information to the operation terminal.

2. The information processing apparatus according to claim 1, wherein the light emission control includes controlling one or more of a start of light emission, an end of light emission, a light emission luminance, a light emission color, light emission time, and a light emission cycle.

3. The information processing apparatus according to claim 1, further comprising an environment sensor configured to detect an environment of the information processing apparatus, wherein
the generator is configured to generate the control information on a basis of a detection result of the environment sensor.

4. The information processing apparatus according to claim 3, wherein the environment sensor includes a sensor configured to detect brightness of the environment.

5. The information processing apparatus according to claim 4, wherein the light-emitting unit is configured to emit light in a case where the brightness is darker than a predetermined brightness, on a basis of the control information.

6. The information processing apparatus according to claim 4, wherein the light-emitting unit is configured to, on a basis of the control information, emit light at a first luminance in a case where the brightness is a first brightness, and emit light at a second luminance that is brighter than the first luminance in a case where the brightness is a second brightness that is darker than the first brightness.

7. The information processing apparatus according to claim 3, wherein the control information includes the detection result of the environment sensor.

8. The information processing apparatus according to claim 1, wherein the generator is configured to generate the control information on a basis of content that is a processing target of the information processing apparatus.

9. The information processing apparatus according to claim 8, further comprising a content analyzer, wherein
the content includes metadata,
the content analyzer is configured to analyze the metadata, and
the generator is configured to generate the control information on a basis of an analysis result of the content analyzer.

10. The information processing apparatus according to claim 8, wherein
the content includes image information, and
the generator is configured to generate the control information on a basis of an analysis result of the image information.

11. The information processing apparatus according to claim 1, wherein the generator is configured to generate the control information on a basis of notification information to a user.

12. The information processing apparatus according to claim 11, further comprising a notification processor configured to generate the notification information, wherein
the control information includes information that causes the light-emitting unit to emit light to correspond to a button associated with the notification information presented to the user, out of a plurality of buttons included in the operation terminal.

13. The information processing apparatus according to claim 1, further comprising a voice processor configured to process voice information accepted from a user, wherein
the generator is configured to generate the control information on a basis of processing of the voice processor.

14. The information processing apparatus according to claim 13, wherein
the voice processor includes a plurality of processors, and is configured to select one of the plurality of processors in response to an operation of the user, and
the control information comprises information corresponding to the processor selected out of the plurality of processors.

15. The information processing apparatus according to claim 1, further comprising:
a connection unit couplable to external equipment; and
an acquisition unit that acquires information related to a function of the external equipment, wherein
the generator is configured to generate the control information on a basis of the information related to the function of the external equipment.

16. The information processing apparatus according to claim 15, wherein the control information includes information that causes the light-emitting unit to emit light to correspond to a button associated with an operation on the external equipment, out of a plurality of buttons included in the operation terminal.

17. An operation terminal comprising:
an operation unit configured to accept an operation of a user;
a light-emitting unit configured to emit light from an operation surface of the operation unit;
a receiver configured to receive control information transmitted from an information processing apparatus; and
a controller configured to perform light emission control of the light-emitting unit on a basis of the control information.

18. The operation terminal according to claim 17, wherein the control information includes information corresponding to a detection result of an environment sensor provided in the information processing apparatus and configured to detect an environment of the information processing apparatus.

19. The operation terminal according to claim 17, wherein the control information includes information corresponding to processing of a voice processor provided in the information processing apparatus and configured to process voice information.

20. An information processing method comprising:
generating, by an information processing apparatus, control information to be used to perform light emission control of a light-emitting unit provided in an operation terminal;
transmitting, by the information processing apparatus, the control information to the operation terminal; and
performing, by the operation terminal, the light emission control of the light-emitting unit on a basis of the control information transmitted from the information processing apparatus.
